(19) United States
(12) Patent Application Publication
(10) Pub. No.: US 2025/0267488 A1
(43) Pub. Date: Aug. 21, 2025

(54) TECHNIQUES FOR REPORTING PREDICTED INTERFERENCE TO ENABLE ADVANCED LINK ADAPTATIONS

(71) Applicant: QUALCOMM Incorporated, San Diego, CA (US)

(72) Inventors: Mohamed Fouad Ahmed MARZBAN, San Diego, CA (US); Wooseok NAM, San Diego, CA (US); Tao LUO, San Diego, CA (US)

(21) Appl. No.: 18/784,183

(22) Filed: Jul. 25, 2024

Related U.S. Application Data
(60) Provisional application No. 63/555,756, filed on Feb. 20, 2024.

(51) Int. Cl. H04W 24/10; H04W 24/08

(52) U.S. Cl. CPC H04W 24/10; H04W 24/08

(57) ABSTRACT

Methods, systems, and devices for wireless communications are described. In some cases, a user equipment (UE) may receive a first control message that indicates the UE is to report predicted interference for multiple resources via a single interference report. As such, the UE may predict interference associated with the multiple resources based on receiving the control message and may determine a payload size of the interference report, a payload structure of the interference report, or both, based at least in part on the predicted interference. Thus, the UE may transmit the interference report in accordance with the determined payload size, the determined payload structure, or both.

### CROSS REFERENCE

The present application for patent claims the benefit of U.S. Provisional Patent Application No. 63/555,756 by MARZBAN et al., entitled “TECHNIQUES FOR REPORTING PREDICTED INTERFERENCE TO ENABLE ADVANCED LINK ADAPTATIONS,” filed Feb. 20, 2024, assigned to the assignee hereof, and expressly incorporated by reference herein.

### FIELD OF TECHNOLOGY

The following relates to wireless communications, including techniques for reporting predicted interference to enable advanced link adaptations.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for reporting predicted interference to enable advanced link adaptations. Generally, the techniques described herein may enable a user equipment (UE) to determine a payload size of an interference report, a payload structure of the interference report, or both, based on predicted interference. For example, the UE may receive a first control message that indicates the UE is to report predicted interference for multiple resources via a single interference report. As such, the UE may predict interference associated with the multiple resources based on receiving the control message and may determine a payload size of the interference report, a payload structure of the interference report, or both, based on the predicted interference. Thus, the UE may transmit the interference report in accordance with the determined payload size, the determined payload structure, or both.

A method for wireless communications by a UE is described. The method may include receiving a first control message that indicates the UE is to report predicted interference for a set of multiple resources via a single interference report, predicting interference associated with the set of multiple resources based on receiving the first control message, determining a payload size of the interference report, a payload structure of the interference report, or both, based on the predicted interference, and transmitting the interference report in accordance with the determined payload size, the determined payload structure, or both.

A UE for wireless communications is described. The UE may include one or more memories storing processor executable code, and one or more processors coupled with the one or more memories. The one or more processors may individually or collectively be operable to execute the code to cause the UE to receive a first control message that indicates the UE is to report predicted interference for a set of multiple resources via a single interference report, predict interference associated with the set of multiple resources based on receiving the first control message, determine a payload size of the interference report, a payload structure of the interference report, or both, based on the predicted interference, and transmit the interference report in accordance with the determined payload size, the determined payload structure, or both.

Another UE for wireless communications is described. The UE may include means for receiving a first control message that indicates the UE is to report predicted interference for a set of multiple resources via a single interference report, means for predicting interference associated with the set of multiple resources based on receiving the first control message, means for determining a payload size of the interference report, a payload structure of the interference report, or both, based on the predicted interference, and means for transmitting the interference report in accordance with the determined payload size, the determined payload structure, or both.

A non-transitory computer-readable medium storing code for wireless communications is described. The code may include instructions executable by one or more processors to receive a first control message that indicates the UE is to report predicted interference for a set of multiple resources via a single interference report, predict interference associated with the set of multiple resources based on receiving the first control message, determine a payload size of the interference report, a payload structure of the interference report, or both, based on the predicted interference, and transmit the interference report in accordance with the determined payload size, the determined payload structure, or both.

In some examples of the method, UEs, and non-transitory computer-readable medium described herein, determining the payload size, the payload structure, or both may include operations, features, means, or instructions for updating the first payload size to a second payload size, the first payload structure to a second payload structure, the first quantity of the set of multiple resources to a second quantity of the set of multiple resources, or any combination thereof, based on the predicted interference, where transmitting the interference report in accordance with the determined payload size, the determined payload structure, or both, includes and transmitting the interference report in accordance with the second payload size, the second payload structure, the second quantity of the set of multiple resources, or any combination thereof, based on the updating.

Some examples of the method, UEs, and non-transitory computer-readable medium described herein may further include operations, features, means, or instructions for transmitting a second control message that indicates the second payload size, the second payload structure, the second quantity of the set of multiple resources, or any combination thereof, based on the updating, where transmitting the interference report in accordance with the second payload size, the second payload structure, the second quantity of the set of multiple resources, or any combination thereof, may be based on transmitting the second control message.

In some examples of the method, UEs, and non-transitory computer-readable medium described herein, the second control message may be a MAC-CE message.

In some examples of the method, UEs, and non-transitory computer-readable medium described herein, the first control message indicates a first payload size and the method, apparatuses, and non-transitory computer-readable medium may include further operations, features, means, or instructions for transmitting a first interference report in accordance the first payload size, the first payload structure, the first quantity of the set of multiple resources, or any combination thereof, receiving a second control message that indicates a second payload size, a second payload structure, a second quantity of the set of multiple resources, or any combination thereof, based on transmitting the first interference report, where determining the payload size, the payload structure, or both, includes, and updating the first payload size to the second payload size, the first payload structure to the second payload structure, the first quantity of the set of multiple resources to the second quantity of the set of multiple resources, or any combination thereof, based on receiving the second control message.

Some examples of the method, UEs, and non-transitory computer-readable medium described herein may further include operations, features, means, or instructions for transmitting, via the first interference report, a request to update the first payload size to the second payload size, the first payload structure to the second payload structure, the first quantity of the set of multiple resources to the second quantity of the set of multiple resources, or any combination thereof, where receiving the second control message may be based on transmitting the first interference report.

In some examples of the method, UEs, and non-transitory computer-readable medium described herein, transmitting the interference report in accordance with the determined payload size, the determined payload structure, or both may include operations, features, means, or instructions for transmitting the interference report in accordance with the second payload size, the second payload structure, the second quantity of the set of multiple resources, or any combination thereof, based on receiving the second control message.

In some examples of the method, UEs, and non-transitory computer-readable medium described herein, the second control message may be a MAC-CE message, a DCI message, or a RRC message.

In some examples of the method, UEs, and non-transitory computer-readable medium described herein, determining the payload size, the payload structure, or both may include operations, features, means, or instructions for determining to transmit a first subset of the predicted interference associated with a first subset of the set of multiple resources via the interference report in accordance with the first payload size, where transmitting the interference report in accordance with the determined payload size, the determined payload structure, or both, includes, transmitting the interference report that indicates the first subset of the predicted interference associated with the first subset of the set of multiple resources in accordance with the first payload size, and transmitting a second control message that indicates a second subset of the predicted interference associated with a second subset of the set of multiple resources based on the determined payload size, the determined payload structure, or both.

In some examples of the method, UEs, and non-transitory computer-readable medium described herein, determining the payload size, the payload structure, or both may include operations, features, means, or instructions for adjusting the payload structure based on the first quantity of the resources relative to a second quantity of the set of multiple resources.

In some examples of the method, UEs, and non-transitory computer-readable medium described herein, adjusting the payload structure may include operations, features, means, or instructions for inputting NULL into a subset of the set of multiple fields based on the first quantity of the resources exceeding the second quantity of the set of multiple resources.

In some examples of the method, UEs, and non-transitory computer-readable medium described herein, adjusting the payload structure may include operations, features, means, or instructions for adjusting a quantity of bits of the set of multiple bits for reporting the predicted interference for each resource of the set of multiple resources based on the first quantity of the resources relative to the second quantity of the set of multiple resources.

In some examples of the method, UEs, and non-transitory computer-readable medium described herein, determining the payload size, the payload structure, or both may include operations, features, means, or instructions for selecting a reporting resource from the set of multiple reporting resources based on the predicted interference and based on a respective payload size, respective payload structure, or both, associated with the selected reporting resource.

In some examples of the method, UEs, and non-transitory computer-readable medium described herein, the predicted interference may be reported per time duration, per frequency, per spatial resource, or any combination thereof.

In some examples of the method, UEs, and non-transitory computer-readable medium described herein, transmitting the interference report may include operations, features, means, or instructions for transmitting the interference report that indicates a set of multiple groups associated with the predicted interference, where each group of the set of multiple groups may be associated with a subset of the predicted interference.

In some examples of the method, UEs, and non-transitory computer-readable medium described herein, each group of the set of multiple groups may be associated with a starting resource and a length.

A method for wireless communications by a network entity is described. The method may include transmitting, to a UE, a first control message that indicates the UE is to report predicted interference for a set of multiple resources via a single interference report, determining a payload size of the interference report, a payload structure of the interference report, or both, and receiving the interference report in accordance with the determined payload size, the determined payload structure, or both.

A network entity for wireless communications is described. The network entity may include one or more memories storing processor executable code, and one or more processors coupled with the one or more memories. The one or more processors may individually or collectively be operable to execute the code to cause the network entity to transmit, to a UE, a first control message that indicates the UE is to report predicted interference for a set of multiple resources via a single interference report, determine a payload size of the interference report, a payload structure of the interference report, or both, and receive the interference report in accordance with the determined payload size, the determined payload structure, or both.

Another network entity for wireless communications is described. The network entity may include means for transmitting, to a UE, a first control message that indicates the UE is to report predicted interference for a set of multiple resources via a single interference report, means for determining a payload size of the interference report, a payload structure of the interference report, or both, and means for receiving the interference report in accordance with the determined payload size, the determined payload structure, or both.

A non-transitory computer-readable medium storing code for wireless communications is described. The code may include instructions executable by one or more processors to transmit, to a UE, a first control message that indicates the UE is to report predicted interference for a set of multiple resources via a single interference report, determine a payload size of the interference report, a payload structure of the interference report, or both, and receive the interference report in accordance with the determined payload size, the determined payload structure, or both.

In some examples of the method, network entities, and non-transitory computer-readable medium described herein, the first control message indicates a first payload size and the method, apparatuses, and non-transitory computer-readable medium may include further operations, features, means, or instructions for receiving a second control message that indicates a second payload size, a second payload structure, a second quantity of the set of multiple resources, or any combination thereof, where determining the payload size, the payload structure, or both, may be based on receiving the second control message, and where receiving the interference report includes and receiving the interference report in accordance with the second payload size, the second payload structure, the second quantity of the set of multiple resources, or any combination thereof, may be based on receiving the second control message.

In some examples of the method, network entities, and non-transitory computer-readable medium described herein, the second control message may be a MAC-CE message.

In some examples of the method, network entities, and non-transitory computer-readable medium described herein, the first control message indicates a first payload size and the method, apparatuses, and non-transitory computer-readable medium may include further operations, features, means, or instructions for receiving a first interference report in accordance the first payload size, the first payload structure, the first quantity of the set of multiple resources, or any combination thereof, where determining the payload size, the payload structure, or both, includes, updating the first payload size to a second payload size, the first payload structure to a second payload structure, the first quantity of the set of multiple resources to a second quantity of the set of multiple resources, or any combination thereof, based on receiving the first interference report, and transmitting a second control message that indicates the second payload size, the second payload structure, the second quantity of the set of multiple resources, or any combination thereof, based on the updating.

Some examples of the method, network entities, and non-transitory computer-readable medium described herein may further include operations, features, means, or instructions for receiving, via the first interference report, a request to update the first payload size to the second payload size, the first payload structure to the second payload structure, the first quantity of the set of multiple resources to the second quantity of the set of multiple resources, or any combination thereof, where transmitting the second control message may be based on transmitting the first interference report.

In some examples of the method, network entities, and non-transitory computer-readable medium described herein, receiving the interference report in accordance with the determined payload size, the determined payload structure, or both may include operations, features, means, or instructions for receiving the interference report in accordance with the second payload size, the second payload structure, the second quantity of the set of multiple resources, or any combination thereof based on transmitting the second control message.

In some examples of the method, network entities, and non-transitory computer-readable medium described herein, the second control message may be a MAC-CE message, a DCI message, or an RRC message.

In some examples of the method, network entities, and non-transitory computer-readable medium described herein, receiving the interference report in accordance with the determined payload size, the determined payload structure, or both may include operations, features, means, or instructions for receiving the interference report that indicates a first subset of the predicted interference associated with a first subset of the set of multiple resources in accordance with the first payload size.

Some examples of the method, network entities, and non-transitory computer-readable medium described herein may further include operations, features, means, or instructions for receiving a second control message that indicates a second subset of the predicted interference associated with a second subset of the set of multiple resources based on receiving the interference report that indicates the first subset of the predicted interference associated with the first subset of the set of multiple resources.

In some examples of the method, network entities, and non-transitory computer-readable medium described herein, the set of multiple resources exceeds a threshold set of multiple resources associated with the interference report.

In some examples of the method, network entities, and non-transitory computer-readable medium described herein, receiving the interference report in accordance with the determined payload size, the determined payload structure, or both may include operations, features, means, or instructions for receiving the interference report in accordance with an adjusted payload structure based on the first quantity of the resources relative to a second quantity of the set of multiple resources.

In some examples of the method, network entities, and non-transitory computer-readable medium described herein, receiving the interference report in accordance with an adjusted payload structure may include operations, features, means, or instructions for receiving a value of NULL via a subset of the set of multiple fields based on the first quantity of the resources exceeding the second quantity of the set of multiple resources.

In some examples of the method, network entities, and non-transitory computer-readable medium described herein, receiving the interference report in accordance with an adjusted payload structure may include operations, features, means, or instructions for receiving the interference report that indicates the predicted interference, where a quantity of bits of the set of multiple bits for reporting the predicted interference for each resource of the set of multiple resources may be adjusted based on the first quantity of the resources relative to the second quantity of the set of multiple resources.

In some examples of the method, network entities, and non-transitory computer-readable medium described herein, the first control message indicates a set of multiple reporting resources associated with a set of multiple payload sizes, associated with a set of multiple payload structures, or associated with both.

In some examples of the method, network entities, and non-transitory computer-readable medium described herein, the predicted interference may be reported per time duration, per frequency, per spatial resource, or any combination thereof.

In some examples of the method, network entities, and non-transitory computer-readable medium described herein, receiving the interference report may include operations, features, means, or instructions for receiving the interference report that indicates a set of multiple groups associated with the predicted interference, where each group of the set of multiple groups may be associated with a subset of the predicted interference.

In some examples of the method, network entities, and non-transitory computer-readable medium described herein, each group of the set of multiple groups may be associated with a starting resource and a length.

### BRIEF DESCRIPTION OF THE DRAWINGS

FIG. 1 shows an example of a wireless communications system that supports techniques for reporting predicted interference to enable advanced link adaptations in accordance with one or more aspects of the present disclosure.

FIG. 2 shows an example of a wireless communications system that supports techniques for reporting predicted interference to enable advanced link adaptations in accordance with one or more aspects of the present disclosure.

FIG. 3 shows examples of interference report payloads that support techniques for reporting predicted interference to enable advanced link adaptations in accordance with one or more aspects of the present disclosure.

FIG. 4 shows an example of a wireless communications system that supports techniques for reporting predicted interference to enable advanced link adaptations in accordance with one or more aspects of the present disclosure.

FIG. 5 shows an example of a timing diagram that supports techniques for reporting predicted interference to enable advanced link adaptations in accordance with one or more aspects of the present disclosure.

FIG. 6 shows an example of a process flow that supports techniques for reporting predicted interference to enable advanced link adaptations in accordance with one or more aspects of the present disclosure.

FIGS. 7 and 8 show block diagrams of devices that support techniques for reporting predicted interference to enable advanced link adaptations in accordance with one or more aspects of the present disclosure.

FIG. 9 shows a block diagram of a communications manager that supports techniques for reporting predicted interference to enable advanced link adaptations in accordance with one or more aspects of the present disclosure.

FIG. 10 shows a diagram of a system including a device that supports techniques for reporting predicted interference to enable advanced link adaptations in accordance with one or more aspects of the present disclosure.

FIGS. 11 and 12 show block diagrams of devices that support techniques for reporting predicted interference to enable advanced link adaptations in accordance with one or more aspects of the present disclosure.

FIG. 13 shows a block diagram of a communications manager that supports techniques for reporting predicted interference to enable advanced link adaptations in accordance with one or more aspects of the present disclosure.

FIG. 14 shows a diagram of a system including a device that supports techniques for reporting predicted interference to enable advanced link adaptations in accordance with one or more aspects of the present disclosure.

FIGS. 15 and 16 show flowcharts illustrating methods that support techniques for reporting predicted interference to enable advanced link adaptations in accordance with one or more aspects of the present disclosure.

### DETAILED DESCRIPTION

In some wireless communications systems, a user equipment (UE) may report interference to a network entity to enable the network entity to schedule the UE in such a way that mitigates or avoids the interference. However, a delay may exist between a first time at which the UE measures and reports the interference and a second time at which the network entity uses the interference measurements in scheduling of the UE, such that interference experienced by the UE may vary between the first time and the second time. That is, the interference reported by the UE at the first time may not be the same as interference experienced by the UE at the second time, such that scheduling of the UE by the network entity based on the reported interference does not effectively mitigate or avoid the interference, reducing system performance. As such, the UE may report predicted interference for future resources to enable advance resource allocation techniques at the network entity and enable the network entity to use enhanced link adaption algorithms. However, in some cases, the predicted interference may vary significantly (e.g., variation may exceed a threshold) across sub-bands, beams, slots, or any combination thereof, while in some other cases, the predicted interference may not vary significantly (e.g., variation may not exceed the threshold) across the sub-bands, the beams, the slots, or any combination thereof. Thus, a payload of an interference report indicating the predicted interference may vary depending on whether there is significant variation in the predicted interference or insignificant variation in the predicted interference. As such, in some cases, the network entity may configure the UE to report interference predicted on a large window of future resources, however, this may result in increased high overhead. Conversely, the network entity may configure the UE to report interference predicted on a small window of future resources (e.g., or a single future resources), however, this may not allow the network entity to perform advanced link adaption techniques (e.g., the report may be insufficient). As such, in some cases, the UE may transmit multiple interference reports indicating the predicted interference. However, transmitting multiple interference reports may increase complexity and increase latency.

Accordingly, techniques described herein may enable the UE to report predicted interference via a single interference report by adjusting or updating a payload size of the interference report, a payload structure of the interference report, or both. For example, in some cases, the network entity may configure the UE to report predicted interference using a single interference report with a fixed payload size. As such, the UE may autonomously update the payload size, the payload structure, a quantity of future resources to report on, or any combination thereof, and may transmit an indication of the updated payload size, the updated payload structure, the update quantity of future resources to report on, or any combination thereof, to the network entity. Additionally, or alternatively, the UE may transmit an interference report in accordance with the fixed payload size and the network entity may update the payload size, the payload structure, the quantity of future resources to report on, or any combination thereof, based on the predicted interference (e.g., in the first interference report). That is, the network entity may transmit an indication of the updated payload size, the updated payload structure, the update quantity of future resources to report on, or any combination thereof, to the UE. Additionally, or alternatively, if the fixed payload size is not sufficient to report the predicted interference, the UE may transmit an interference report including a first portion of the predicted interference using the fixed payload size and transmit a control message including a second portion of the predicted interference according to an updated payload size.

Additionally, or alternatively, the UE may modify a structure of the interference report. For example, in some cases, the network entity may configure the UE to report predicted interference using a single interference report with a fixed payload size and, if the fixed payload size includes more fields than needed to report predicted interference for a quantity of future resources, the UE may report NULL on fields with no predicted interference. Additionally, or alternatively, the UE may vary encoding, quantization, or both, of the predicted interference based on the quantity of future resources. Additionally, or alternatively, the network entity may configure the UE with multiple reporting resources, where each reporting resource is associated with a different payload size, a different structure, or both. As such, the UE may select a report resource from the multiple reporting resources based on the predicted interference. In some cases, the UE may report predicted interference for each time interval (e.g., slot, symbol), each frequency interval (e.g., sub-band, resource block (RB)), each spatial resource (e.g., beam), or any combination thereof. Additionally, or alternatively, the UE may group future resources and report predicted interference for each group of future resources.

Aspects of the disclosure are initially described in the context of wireless communications systems. Aspects of the disclosure are then described in the context of interference report payloads, a timing diagram, and a process flow. Aspects of the disclosure are further illustrated by and described with reference to apparatus diagrams, system diagrams, and flowcharts that relate to techniques for reporting predicted interference to enable advanced link adaptations.

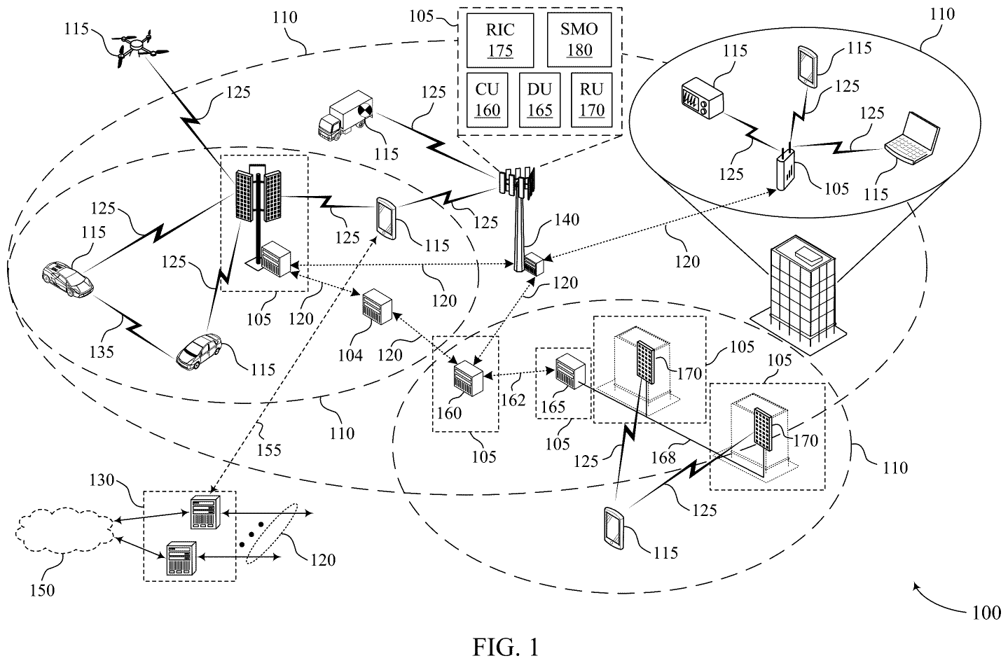

FIG. 1 shows an example of a wireless communications system 100 that supports techniques for reporting predicted interference to enable advanced link adaptations in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the wireless communications system 200 may support UE 115 reporting of predicted interference via a single interference report via adjustment or updating of a payload size of the interference report, a payload structure of the interference report, or both. For example, in some cases, the network entity 105 may configure the UE 115 to report predicted interference using a single interference report with a fixed payload size. As such, the UE 115 may autonomously update the payload size, the payload structure, a quantity of future resources to report on, or any combination thereof, and may transmit an indication of the updated payload size, the updated payload structure, the update quantity of future resources to report on, or any combination thereof, to the network entity 105. Additionally, or alternatively, the UE 115 may transmit an interference report using the fixed payload size and the network entity 105 may update the payload size, the payload structure, the quantity of future resources to report on, or any combination thereof, based on the predicted interference (e.g., in the first interference report). That is, the network entity 105 may transmit an indication of the updated payload size, the updated payload structure, the update quantity of future resources to report on, or any combination thereof, to the UE 115. Additionally, or alternatively, if the fixed payload size is not sufficient to report the predicted interference, the UE 115 may transmit an interference report including a first portion of the predicted interference using the fixed payload size and transmit a control message including a second portion of the predicted interference.

Additionally, or alternatively, the UE 115 may modify a structure of the interference report. For example, in some cases, the network entity 105 may configure the UE 115 to report predicted interference using a single interference report with a fixed payload size and, if the fixed payload size includes more fields than needed to report predicted interference for a quantity of future resources, the UE 115 may report NULL on fields with no predicted interference. Additionally, or alternatively, the UE 115 may vary encoding, quantization, or both, of the predicted interference based on the quantity of future resources. Additionally, or alternatively, the network entity 105 may configure the UE 115 with multiple reporting resources, where each reporting resource is associated with a different payload size, a different structure, or both. As such, the UE 115 may select a report resource from the multiple reporting resources based on the predicted interference. In some cases, the UE 115 may report predicted interference for each time interval (e.g., slot, symbol), each frequency interval (e.g., sub-band, RB), each spatial resource (e.g., beam), or any combination thereof. Additionally, or alternatively, the UE 115 may group future resources and report predicted interference for each group of future resources.

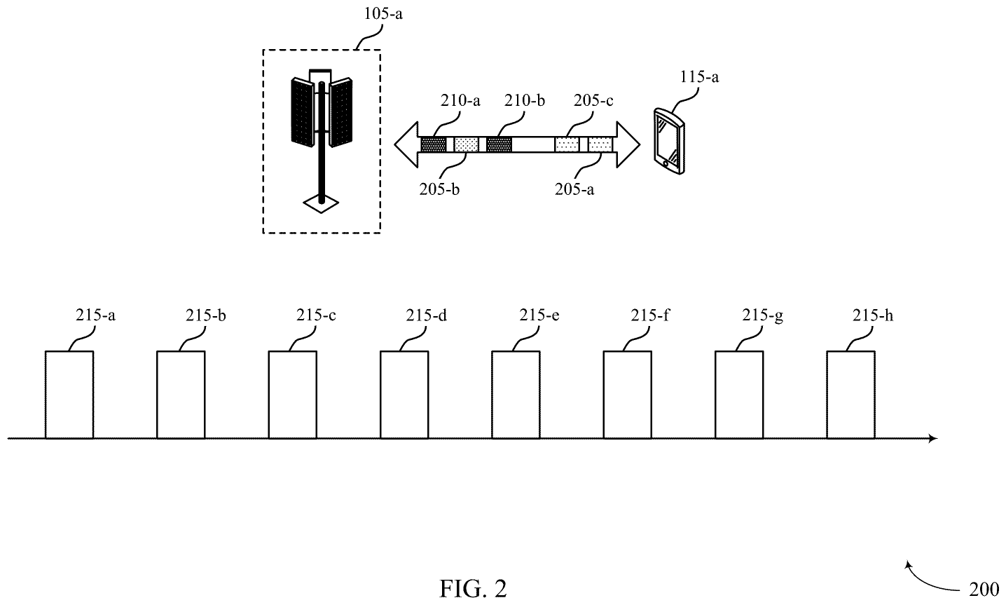

FIG. 2 shows an example of a wireless communications system 200 that supports techniques for reporting predicted interference to enable advanced link adaptations in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a) and one or more network entities 105 (e.g., a network entity 105-a), which may be examples of the corresponding devices as described herein.

In some wireless communications systems, such as the wireless communications system 200, variations in interference experienced by a UE 115, such as the UE 115-a, a network entity 105, such as the network entity 105-a, or both, may impact performance of the wireless communications system 200 (e.g., a 5G system). As such, to support interference mitigation, the UE 115-a may report measured interference to the network entity 105-a to enable the network entity 105-a to schedule the UE 115-a in such a way that mitigates or avoids the interference. However, a delay may exist between a first time at which the UE 115-a measures and reports the interference and a second time at which the network entity 105-a schedules the UE 115-a based on the reported interference, such that interference experienced by the UE 115-a may vary between the first time and the second time. That is, the interference reported by the UE 115-a at the first time may not be the same as interference experienced by the UE 115-a at the second time (e.g., may not be accurate at the second time, the interference may change), such that scheduling of the UE 115-a by the network entity 105-a does not effectively mitigate or avoid the interference, reducing system performance.

As such, the UE 115-a may report predicted interference for future resources 215 to enable advance resource allocation techniques at the network entity 105-a and enable the network entity 105-a to use enhanced link adaption algorithms. That is, one or more parameters (e.g., configuration parameters) at neighbor network entities 105 may impact temporal, frequency, spatial, or any combination thereof, correlation of interference (e.g., inter-cell interference) observed by the UE 115-a. For example, interference experienced (e.g., observed) by the UE 115-a and variations in the interference may be based on scheduling behavior of the network entities 105, such as scheduling type (e.g., proportional fair, round robin), quantity of active UEs 115, traffic type at the neighbor network entities 105, resource utilization (e.g., loading), beam management, channel variations (e.g., between interfering network entities 105 and the UE 115-a), or any combination thereof. As such, the UE 115-a (e.g., and/or network entity 105-a) may observe interference (e.g., interference patterns) on previous resources, such that the UE 115-a (e.g., and/or network entity 105-a) may predict interference on future resources 215, enabling advances scheduling techniques. In some cases (e.g., due to interference patterns observed at the UE 115-a being based on many factors), the UE 115-a may utilize a machine learning model (e.g., artificial intelligence) to predict interference for the future resources 215. That is, the machine learning model may learn interference pattern variations from previous resources to enable interference prediction for the future resources 215.

In some cases, the wireless communications system 200 may implement one or more enhancements at the UE 115-a, the network entity 105-a, or both, based on the predicted interference (e.g., from the machine learning model). For example, a scheduler (e.g., link adaption) at the network entity 105-a may perform scheduler enhancements, such that the scheduler may exclude resources predicted (e.g., anticipated) with high interference (e.g., a threshold level of interference) from a resource allocation, may perform modulation and coding scheme (MCS) adaption or rank adaption based on the predicted interference, or both, which may increase system throughput and energy saving at the network entity 105-a. Additionally, or alternatively, a radio frequency (e.g., digital) front end at the UE 115-a may perform front end enhancement, such that the radio frequency front end may perform automatic gain control (AGC) gain state prediction based on the predicted interference, may activate or deactivate additional reception blocks (e.g., front end linearization, additional filters, etc.) based on the predicted interference, or both. Additionally, or alternatively, the UE 115-a may perform Demback enhancements, such that the UE 115-a may perform autocorrelation matrix, Rₙₙ, prediction (e.g., smoothing) for advances receivers based on the predicted interference, may select one or more receiver algorithms based on the predicted interference (e.g., signal to noise ratio (SINR)), or both. Additionally, or alternatively, the UE 115-a may perform channel state feedback (CSF) enhancements, sch that the UE 115-a may reduce overhead associated with interference measurement resources based on the predicted interference, may adjust channel state information (CSI) prediction and compression (e.g., as well as channel prediction) based on the predicted interference, or both. Such enhancements at the UE 115-a may result in improved reliability and power saving at the UE 115-a.

In some cases, interference variation may be greater than channel variations (e.g., especially for beamformed channels). As such, predicting the autocorrelation matrix, Rₙₙ, to enable advanced scheduling techniques and advance reference signal designs schemes may increase (e.g., enhance) overall throughput and latency of the wireless communications system 200. Additionally, interference reporting from the UE 115-a to the network entity 105-a enables advanced resource allocation strategies at the network entity 105-a and enables enhanced link adaption algorithms. For example, the network entity 105-a may schedule the UE 115-a and adapt MCS and rank of transmissions based on the predicted interference. That is, the network entity 105-a may adapt the MCS to the predicted interference (e.g., to increase user perceived throughput (UPT) gains compared to conventional scheduling techniques) and may avoid scheduling the UE 115-a on resources expected to have high interference (e.g., interference above a threshold).

To enable advanced scheduling and link adaption strategies, as described above, the UE 115-a may report predicted interference on multiple future resources 215 (e.g., slots, sub-bands, beams). However, in some cases, the predicted interference may vary significantly (e.g., exceed a threshold variance) across sub-bands, beams, slots, or any combination thereof, while in some other cases, the predicted interference may not vary significantly (e.g., may fail to exceed a threshold variance) across the sub-bands, the beams, the slots, or any combination thereof. Thus, a payload of an interference report 210 indicating the predicted interference may vary depending on whether there is significant variation in the predicted interference or insignificant variation in the predicted interference (e.g., and an environment of the UE 115-a). As such, in some cases (e.g., to enable advanced link adaption techniques for significant variation), the network entity 105-a may configure the UE 115-a to report interference predicted on a large window of future resources 215, however, this may result in increased high overhead. Conversely (e.g., to reduce signaling overhead), the network entity 105-a may configure the UE 115-a to report interference predicted on a small window of future resources 215 (e.g., or a single future resource 215), regardless of interference variations, however, this may not allow the network entity 105-a to perform advanced link adaption techniques (e.g., the report may be insufficient for significant variations in predicted interference). As such, in some cases, the UE 115-a may transmit multiple interference reports 210 indicating the predicted interference to enable adaption of the payload of the interference report 210. However, transmitting multiple interference reports 210 may increase complexity and increase latency.

Accordingly, techniques described herein may enable the UE 115-a to report predicted interference via a single interference report 210 by adjusting or updating a payload size of the interference report 210, a payload structure of the interference report 210, or both, to reduce reporting overhead, reduce complexity, reduce latency, and support efficient interference prediction reporting to enable advanced link adaption techniques. For example, the UE 115-a may receive a control message 205-a indicating for (e.g., configuring) the UE 115-a to report predicted interference via a single interference report 210 (e.g., CSI report) with a fixed payload size (e.g., and a fixed payload structure). Additionally, in some cases, the control message 205-a may indicate a set of future resources 215 (e.g., future physical uplink control channel (PUCCH) resources) for the UE 115-a to report predicted interference on. As such, the UE 115-a may autonomously update a payload size of the interference report 210, a structure of the interference report 210, or both, based on the predicted interference (e.g., variations in interference fluctuations) to enable adapted (e.g., intelligent) scheduling and link adaption by the network entity 105-a.

That is, the UE 115-a may transmit an interference report 210-a, with the fixed payload size, indicating predicted interference for a pre-configured quantity of future resources 215. For example, the pre-configured quantity of future resources 215 may be three future resources 215, such that the UE 115-a may transmit the interference report 210-a indicating predicted interference for a future resource 215-a, a future resource 215-b, and a future resource 215-c. Additionally, the UE 115-a may transmit, to the network entity 105-a, a control message 205-b (e.g., medium access control-control element (MAC-CE)) indicating an updated payload size, an updated payload structure, or both. The updated payload structure may indicate an updated quantity of future resources 215 for which interference is reported, as well as one or more parameters associated with the predicted interference reporting (e.g., quantization, coding, grouping of future resources 215). Thus, the UE 115-a may transmit an interference report 210-b according to the updated payload size, the updated payload structure, or both, indicating predicted interference for a future resource 215-d, a future resource 215-e, and a future resource 215-f.

In some cases, the UE 115-a may continue to update the payload size, the payload structure, or both, after each pre-configured quantity of future resources 215 (e.g., based on the predicted interference reported in the interference report 210-b). For example, the UE 115-a may transmit an additional control message 205 after the interference report 210-b updating the payload size, the payload structure, or both, a second time, and may transmit an additional interference report 210 according to the newly updated payload size, the newly updated payload structure, or both, indicating predicted interference for a future resource 215-g, a future resource 215-h, and a future resource 215-i (e.g., not depicted). In some other cases, the UE 115-a may determine not to update the payload size, the payload structure, or both, after transmitting the interference report 210-b (e.g., based on the predicted interference reported in the interference report 210-b), such that the UE 115-a transmits an additional interference report indicating predicted interference for the future resource 215-g, the future resource 215-h, and the future resource 215-i according to the same payload size, the same payload structure, or both, associated with the interference report 210-b.

Additionally, or alternatively, the network entity 105-a may indicate updates in payload size, payload structure, or both, to the UE 115-a based on predicted interference. For example, the UE 115-a may receive a control message 205-a indicating for the UE 115-a to report predicted interference via a single interference report 210 (e.g., CSI report) with a fixed payload size (e.g., and a fixed payload structure). Additionally, in some cases, the control message 205-a may indicate a set of future resources 215 for which the UE 115-a is to report predicted interference, such as the future resource 215-a, the future resource 215-b, the future resource 215-c, and the future resource 215-d. As such, the UE 115-a may transmit an interference report 210-a indicating predicted interference for the future resource 215-a, the future resource 215-b, the future resource 215-c, and the future resource 215-d according to the fixed payload size. Additionally, the network entity 105-a may transmit a control message 205-c indicating an updated payload size, an updated payload structure, or both, based on the predicted interference reported in the interference report 210-a (e.g., network entity 105-a observance of the predicted interference), such that the UE 115-a may transmit an interference report 210-b indicating predicted interference for the future resource 215-e, the future resource 215-f, the future resource 215-g, and the future resource 215-h according to the updated payload size, the updated payload structure, or both. In such cases, the UE 115-a may report the predicted interference for the future resource 215-e, the future resource 215-f, the future resource 215-g, and the future resource 215-h based on the control message 205-c indicating the UE 115-a is to report predicted interference for four future resources 215.

In some cases, the updated payload size, the updated payload structure, or both, indicated to the UE 115-a via the control message 205-b may be based on a recommendation or request from the UE 115-a. That is, UE 115-a may transmit a control message 205-b (e.g., MAC-CE) requesting the updated payload size, the updated payload structure, or both, such that the control message 205-c may include an acknowledgement, or confirmation, of the updated payload size, the updated payload structure, or both.

Additionally, or alternatively, the UE 115-a may receive a control message 205-a indicating for the UE 115-a to report predicted interference for a set of future resources 215 via a single interference report 210 (e.g., CSI report) with a fixed payload size (e.g., and a fixed payload structure) and, if the fixed payload size is not large enough to transmit the predicted interference for the set of future resources 215, the UE 115-a may report remaining predicted interference using an additional control message 205. That is, for example, the UE 115-a may receive a control message 205-a indicating for the UE 115-a to report predicted interference for the future resource 215-a, the future resource 215-b, the future resource 215-c, the future resource 215-d, and the future resource 215-e using a single interference report 210 with a fixed payload size. However, the fixed payload size may not be large enough to report the predicted interference (e.g., report sufficient representation of predicted interference fluctuations) for the future resource 215-a, the future resource 215-b, the future resource 215-c, the future resource 215-d, and the future resource 215-e. As such, the UE 115-a may transmit an interference report 210-a indicating predicted interference for the future resource 215-a, the future resource 215-b, and the future resource 215-c according to the fixed payload size, and may transmit a control message 205-b indicating predicted interference for the future resource 215-d and the future resource 215-e according to an updated payload size. In another example, the UE 115-a may be configured to report predicted interference on 10 future resources 215 using an interference report 210 (e.g., uplink control information (UCI)), such that interference predictions on additional future resources 215 may be reported by the UE 115-a via a control message 205 (e.g., MAC-CE).

Though described in the context of predicted interference (e.g., predicted interference information), this is not to be regarded as a limitation of the present disclosure. In this regard, predicted interference may further be classified in terms of predicted interference power, predicted SINR, predicted autocorrelation matrix (e.g., Rₙₙ), or the like thereof.

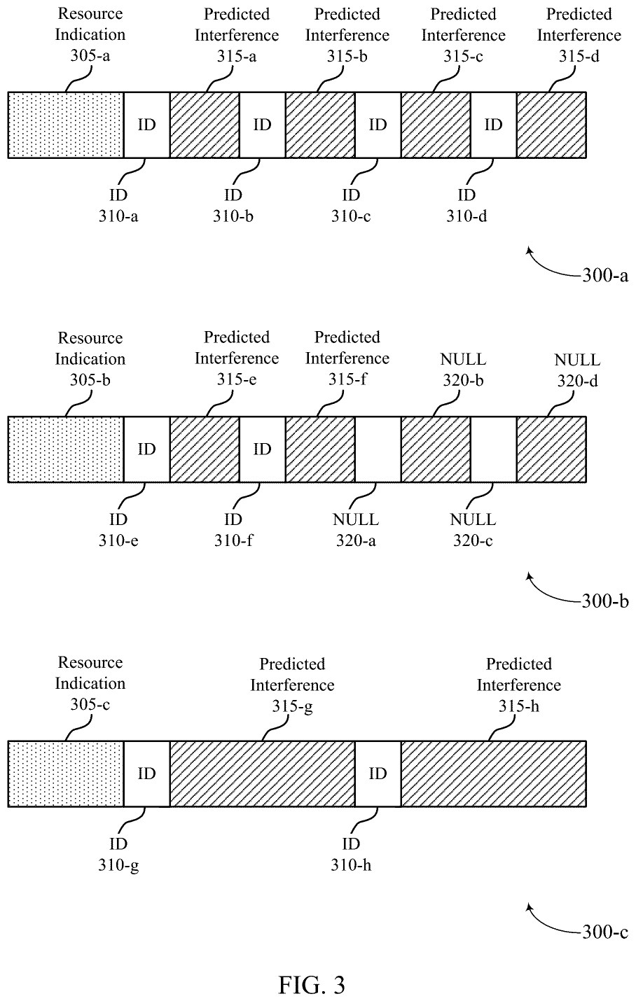

FIG. 3 shows examples of interference report payloads 300 (e.g., an interference report payload 300-a, an interference report payload 300-b, and an interference report payload 300-c) that supports techniques for reporting predicted interference to enable advanced link adaptations in accordance with one or more aspects of the present disclosure. In some cases, the interference report payloads 300 may implement or be implemented by aspects of the wireless communications system 100, the wireless communications system 200, or both. For example, the interference report payloads 300 may be implemented by one or more UEs 115 and one or more network entities 105, which may be examples of the corresponding devices as described herein.

As described previously, in some cases, a UE 115 may adjust or update a payload structure of an interference report to enable the UE 115 to report predicted interference for one or more future resources via a single interference report. For example, the UE 115 may receive a control message indicating for the UE 115 to report predicted interference 315 via a single interference report with (e.g., conditioned to) a fixed payload size. As such, the UE 115 may measure predicted interference 315 for the one or more future resources and report the predicted interference 315 via the single interference report with the fixed payload size, where the UE 115 may adjust a payload structure of the interference report based on a quantity of the one or more future resources. As such, the UE 115 may indicate, via the interference report (e.g., in the payload), the quantity of the one or more future resources with predicted interference 315. That is, the interference report may include a resource indication 305 indicating the quantity of the one or more future resources, an identifier (ID) 305 associated with each future resource of the one or more future resources, and predicted interference 315 associated with each ID 310.

In some cases, the fixed payload size may be associated with reporting interference for a threshold quantity of future resources (e.g., the fixed payload size may be associated with a default payload structure that may be adjusted by the UE 115). For example, the fixed payload size may be associated with (e.g., support) reporting predicted interference 315 for four future resources. As such, in some cases, the UE 115 may transmit the interference report payload 300-a indicating predicted interference 315 for four future resources (e.g., the UE 115 may predict 4 variations in the predicted interference 315 and thus utilizes all fields in the interference report payload 300-a). In such cases, the interference report payload 300-a may indicate, via a resource indication 305-a, that the interference report payload 300-a indicates predicted interference 315 for four future resources, including a first future resource indicated by an ID 310-a, a second future resource indicated by an ID 310-b, a third future resource indicated by an ID 310-c, and a fourth future resource indicated by an ID 310-d. Additionally, the interference report payload 300-a may indicate predicted interference 315-a associated with the ID 310-a (e.g., the first future resource), predicted interference 315-b associated with the ID 310-b (e.g., the second future resource), predicted interference 315-c associated with the ID 310-c (e.g., the third future resource), and predicted interference 315-d associated with the ID 310-d (e.g., the fourth future resource).

In some cases, the fixed payload size may be larger than a quantity of the one or more future resources with predicted interference 315. That is, the threshold quantity of future resources associated with the fixed payload size may be greater than the quantity of the one or more future resources reported by the UE 115. As such, in some cases, one or more fields (e.g., CSI fields) associated with the fixed payload size may not be used by the UE 115 and the UE 115 may input (e.g., report) an indication of no predicted interference 315, such as an indication of NULL 320, in each field with no predicted interference (e.g., each unused field). For example, the fixed payload size may be associated with reporting predicted interference 315 for four future resources (e.g., may include multiple fields for reporting predicted interference for the four future resources) and the UE 115 may transmit the interference report payload 300-b indicating predicted interference 315 for two future resources (e.g., the UE 115 may predict 2 variations in the predicted interference 315 and thus utilizes a portion of the fields in the interference report payload 300-b). In such cases, the interference report payload 300-b may indicate, via a resource indication 305-b, that the interference report payload 300-b indicates predicted interference 305 for two future resources, including a fifth future resource indicated by an ID 310-e, and a fifth future resource indicated by an ID 310-f. Additionally, the interference report payload 300-b may indicate predicted interference 315-e associated with the ID 310-e (e.g., the fourth future resource) and predicted interference 315-f associated with the ID 310-f (e.g., the fifth future resource). Further, the UE 115 may input a NULL 320-a, a NULL 320-b, a NULL 320-c, and a NULL 320-d in four fields not used by the UE 115 (e.g., fields without an ID 310 or interference 315).

In some cases, the fixed payload size may be larger than a quantity of the one or more future resources with predicted interference 315, such that the UE 115 may modify (e.g., adjust or update) an encoding, a quantization, or both, of the predicted interference 315 based on a quantity of the one or more future resources. In other words, the UE 115 may modify a quantity of bits used to report predicted interference 315 for each future resource of the one or more future resources. For example, the fixed payload size may be associated with reporting predicted interference 315 for four future resources (e.g., a quantity of bits in each field of the fixed payload is based on reporting predicted interference 315 for four future resources) and the UE 115 may transmit the interference report payload 300-c indicating predicted interference 315 for two future resources (e.g., the UE 115 may predict 2 variations in the predicted interference 315), such that the UE 115 modifies an encoding, a quantization, or both, of the predicted interference 315 for the two future resources. In such cases, the interference report payload 300-c may indicate, via a resource indication 305-c, that the interference report payload 300-c indicates predicted interference 315 for two future resources, including a seventh future resource indicated by an ID 310-g, and an eighth future resource indicated by an ID 310-h. Additionally, the interference report payload 300-c may indicate predicted interference 315-g associated with the ID 310-g (e.g., the seventh future resource) and predicted interference 315-h associated with the ID 310-h (e.g., the eight future resource), where a quantity of bits used to report the predicted interference 315-g and a quantity of bits used to report the predicted interference 315-h is increased (e.g., doubled) based on the UE 115 reporting predicted interference 315 for two future resources (e.g., instead of four future resources).

In some cases, a mapping between an encoding, a quantization, or both, of predicted interference and a quantity of future resources associated with the predicted interference 315 may be pre-configured at the UE 115 (e.g., based on one or more standardized rules). Additionally, or alternatively, the mapping between the encoding, the quantization, or both, of the predicted interference 315 and the quantity of future resources associated with the predicted interference 315 may be indicated by the network entity 105. That is, the network entity 105 may transmit a control message (e.g., RRC, MAC-CE, DCI) indicating the mapping between the encoding, the quantization, or both, of the predicted interference 315 and the quantity of future resources associated with the predicted interference.

Though described in the context of reporting predicted interference 315 for a quantity of one or future resources less than a threshold quantity of future resources associated with a fixed payload size, this is not to be regarded as a limitation of the present disclosure. In this regard, the UE 115 may decrease a quantity of bit a quantity of bits used to report predicted interference 315 for each future resource of the one or more future resources based on the quantity of one or future resources being greater than the threshold quantity of future resources associated with the fixed payload size.

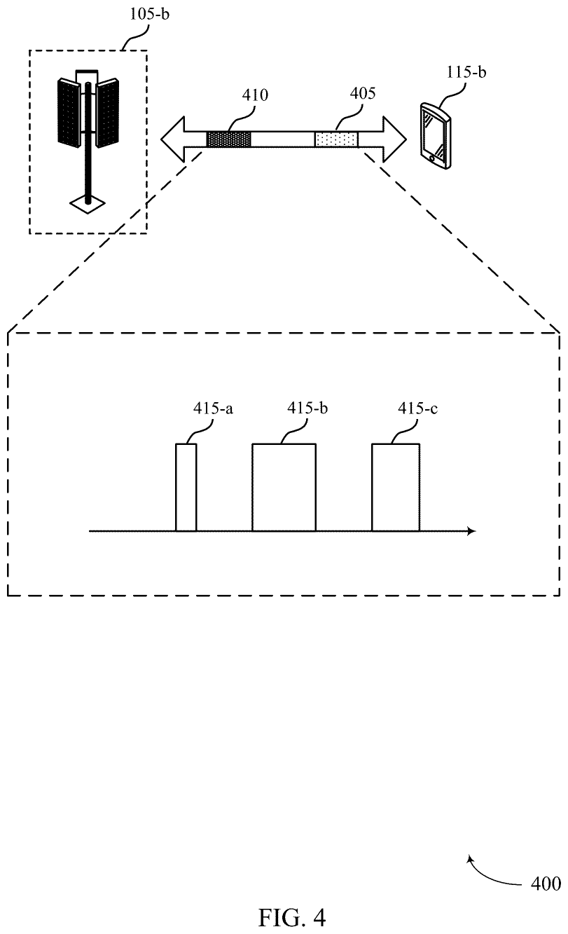

FIG. 4 shows an example of a wireless communications system 400 that supports techniques for reporting predicted interference to enable advanced link adaptations in accordance with one or more aspects of the present disclosure. In some cases, the wireless communications system 400 may implement or be implemented by aspects of the wireless communications system 100, the wireless communications system 200, the interference report payloads 300, or any combination thereof. For example, the wireless communications system 400 may include one or more UEs 115 (e.g., a UE 115-b) and one or more network entities 105 (e.g., a network entity 105-b), which may be examples of the corresponding devices as described herein.

In some cases, to enable a UE 115, such as the UE 115-b, to report predicted interference for one or more future resources via a single interference report 410, a network entity 105, such as the network entity 105-b, may configure the UE 115 with multiple uplink reporting resources 415 (e.g., PUCCH resources), where each of the multiple uplink reporting resources 415 is associated with a different payload size, a different payload structure, or both. For example, the network entity 105-b may transmit, to the UE 115-b, a control message 405 (e.g., MAC-CE, RRC, DCI) indicating (e.g., assigning) multiple uplink reporting resources 415, including an uplink reporting resource 415-a, an uplink reporting resource 415-b, and an uplink reporting resource 415-c, for the UE 115-b to report predicted interference. In such cases, each of the uplink reporting resource 415-a, the uplink reporting resource 415-b, and the uplink reporting resource 415-c may be associated with a different payload size, a different payload structure, or both. For example, the uplink reporting resource 415-a may be associated with a first payload size, the uplink reporting resource 415-b may be associated with a second payload size, and the uplink reporting resource 415-c may be associated with a third payload size, where the first payload size is smaller than the third payload size, which is smaller than the second payload size.

Thus, the UE 115-b may predict interference (e.g., measure predicted interference, generate predicted interference, determine predicted interference) on one or more future resources and may determine a payload size associated with (e.g., needed) reporting the predicted interference based on the predicted interference (e.g., based on fluctuations in the predicted interference). Thus, the UE 115-b may select one of the uplink reporting resource 415-a, the uplink reporting resource 415-b, and the uplink reporting resource 415-c based on the determined payload size (e.g., predicted interference payload). In other words, the UE 115-b may compare the determined payload size to the first payload size, the second payload size, and the third payload size to determine which uplink reporting resource 415 to use to transmit an indication of the predicted interference (e.g., interference report). Thus, the UE 115-b may report the predicted interference via the selected uplink reporting resource 415 (e.g., having a payload size that meets the determine payload).

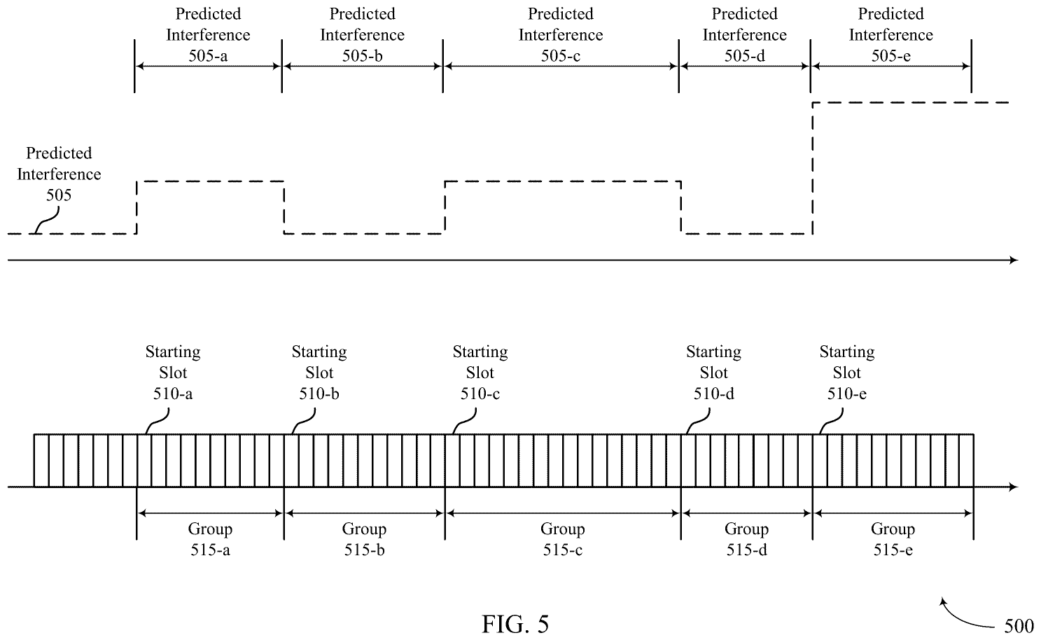

FIG. 5 shows an example of a timing diagram 500 that supports techniques for reporting predicted interference to enable advanced link adaptations in accordance with one or more aspects of the present disclosure. In some cases, the timing diagram 500 may implement or be implemented by aspects of the wireless communications system 100, the wireless communications system 200, the interference report payloads 300, the wireless communications system 400, or any combination thereof. For example, the timing diagram 500 may include one or more UEs 115 and one or more network entities 105, which may be examples of the corresponding devices as described herein.

In some cases, to enable a UE 115 to report predicted interference for one or more future resources via a single interference report, the UE 115 may report predicted interference on a group-based basis. That is, the UE 115 may report predicted interference on grouped resources to reduce reporting overhead. For example, the UE 115 may measure (e.g., generate, determine) predicted interference 505 over multiple time resources (e.g., slots, symbols), multiple frequency resources (e.g., sub-bands, resource blocks), multiple spatial resources (e.g., beams), or any combination thereof, and may divide the predicted interference into groups 515. That is, the UE 115 may divide the time resources, the frequency resources, the spatial resources, or any combination thereof, into multiple groups 515 based on the predicted interference.

As such, the UE 115 may report a quantity of groups 515 (e.g., predicted interference groups) and predicted interference associated with each group 515. In such cases, the UE 115 may report a starting resource (e.g., starting slot 510, starting sub-band, starting beam) and a length (e.g., in quantity of slots, sub-bands, beams) or ending resource associated with each group 515 (e.g., each group of resources). Additionally, or alternatively, the UE 115 may report the predicted interference associated with each group in terms of a mean predicted interference. That is, the UE 115 may predict interference associated with each resource (e.g., time, frequency, spatial) in a group 515 and may average the predicted interference across the resources in the group 515 to determine the mean predicted interference for the group 515. In some examples, the UE 115 may group resources, such that predicted interference associated with each resource in a group 515 is within a threshold tolerance of a mean predicted interference for the group 515.

For example, as depicted in FIG. 5, the UE 115 may determine predicted interference 505 over multiple slots (e.g., time resources) and may divide the predicted interference 505 into 5 groups (e.g., based on variations in the predicted interference 505), including a group 515-a, a group 515-b, a group 515-c, a group 515-d, and a group 515-d. As such, the UE 115 may report a starting slot 510 and a length (e.g., in a quantity of slots) or ending slot associated with each group 515, as well as a subset of the predicted interference 505 associated with each group 515. For example, the UE 115 may transmit an indication of a starting slot 510-a and a length of 10 slots associated with the group 515-a, a starting slot 510-b and a length of 11 slots associated with the group 515-b, a starting slot 510-c and a length of 16 slots associated with the group 515-c, a starting slot 510-d and a length of 9 slots associated with the group 515-d, and a starting slot 510-e and a length of 11 slots associated with the group 515-e. Additionally, the UE 115 may transmit an indication of predicted interference 505-a associated with the group 515-a, predicted interference 505-b associated with the group 515-b, predicted interference 505-c associated with the group 515-c, predicted interference 505-d associated with the group 515-d, and predicted interference 505-e associated with the group 515-e.

Additionally, or alternatively, the UE 115 may report predicted interference 505 for each time resource, each frequency resource, each spatial resource, or any combination thereof.

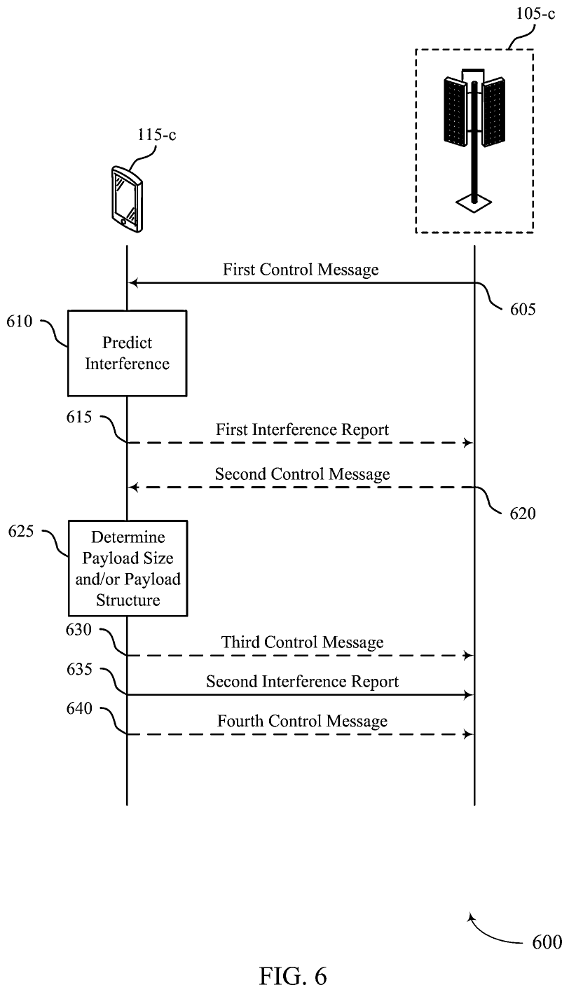

FIG. 6 shows an example of a process flow 600 that supports techniques for reporting predicted interference to enable advanced link adaptations in accordance with one or more aspects of the present disclosure. In some cases, the process flow 600 may implement or be implemented by aspects of the wireless communications system 100, the wireless communications system 200, the interference report payloads 300, the wireless communications system 400, the timing diagram 500, or any combination thereof. For example, the process flow 600 may include one or more UEs 115 (e.g., a UE 115-c) and one or more network entities 105 (e.g., a network entity 105-c), which may be examples of the corresponding devices as described herein.

At 605, the UE 115-c may receive, from the network entity 105-c, a first control message that indicates the UE is to report predicted interference for a set of resources (e.g., future resources) via a single interference report. In some cases, the first control message may indicate a first payload size (e.g., quantity of bits), a first payload structure (e.g., quantity of fields, a first quantity of resources for which to report predicted interference, encoding, quantization, etc.), or any combination thereof. In some cases, the first payload size may be associated with a first quantity of bits for reporting predicted interference.

At 610, the UE 115-c may predict interference (e.g., measure predicted interference) associated with the set of resources based on receiving the first control message.

In some cases, at 615, the UE 115-c may transmit a first interference report indicating the predicted interference in accordance with the first payload size, the first payload structure, or both. In some cases, the first interference report may include a request to update the first payload size to a second payload size, the first payload structure to a second payload structure, or both.

In some cases, at 620, the UE 115-c may receive, from the network entity 105-c, a second control message (e.g., MAC-CE message, RRC message, DCI message) indicating the second payload size, the second payload structure (e.g., a second quantity of the set of resources), or both, based at least in part on transmitting the first interference report. That is, the network entity 105-c may update the first payload size to the second payload size, the first payload structure to the second payload structure, or both, based on the predicted interference indicated in the first interference report. In some cases, the network entity 105-c may transmit the second control message based on the request included in the first interference report.

At 625, the UE 115-c may determine a payload size of a second interference report, a payload structure of a second interference report, or both, based on the predicted interference. For example, in some cases, the UE 115-c may update (e.g., autonomously) the first payload size to a third payload size, the first payload structure to a third payload structure, or both, based on the predicted interference. In some cases, the UE 115-c may update the first payload structure to the third payload structure based on a first quantity of resources associated with the first payload size relative to a second quantity of resources associated with the predicted interference (e.g., a second quantity of the set of resources). In some cases, the UE 115-c may input NULL into a subset of fields based on the first quantity of resources associated with the first payload size exceeding the second quantity of resources associated with the predicted interference. In some other cases, the UE 115-c may adjust a quantity of bits (e.g., from the first quantity of bits) for reporting the predicted interference for each resource of the set of resources based on the first quantity of the resources relative to the second quantity resources.

In some cases, the UE 115-c may update the first payload size to a third payload size, the first payload structure to a third payload structure, or both, based on selecting a reporting resource from multiple reporting resources configured for the UE 115-c, where the selected reporting resource is associated with the third payload structure, the third payload size, or both.

Additionally, or alternatively, the UE 115-c may update the first payload size to the second payload size, the first payload structure to the second payload structure, or both, based on the second control message.

In some cases, the UE 115-c may determine to transmit a first subset of the predicted interference in the second interference report and a second subset of the predicted interference in a fourth control message. Thus, the UE 115-a may update the first payload size to the second payload size, the first payload structure to the second payload structure, or both, for the fourth control message.

In some cases, at 630, the UE 115-c may transmit, to the network entity 105-c, a third control message (e.g., MAC-CE message) indicating the third payload size, the third payload structure, or both, based on updating (e.g., autonomously) the first payload size to the third payload size, the first payload structure to the third payload structure, or both, based on the predicted interference.

At 635, the UE 115-c may transmit, to the network entity 105-c, the second interference report. In some cases, the second interference report may be based on the predicted interference (e.g., measured at 610) and may be reported in accordance with the second payload size, the second payload structure, or both. In some other cases, the second interference report may be based on additional predicted interference and reported in accordance with the second payload size, the second payload structure, or both (e.g., updated by the network entity 105-c).

In some cases (e.g., based on determining to transmit the predicted interference in subsets), the UE 115-c may transmit the first subset of the predicted interference associated with a first subset of the set of resources via the second interference report in accordance with the first payload size and may transmit, at 640, the fourth control message indicating a second subset of the set of resources based on transmitting the second interference report indicating the first subset of the predicted interference associated with the first subset of the set of resources (e.g., in accordance with the second payload size, the second payload structure, or both).

In some cases, the predicted interference may be reported per time duration (e.g., time resource), per frequency (e.g., frequency resource), per spatial resource, or any combination thereof.

In some cases, the second interference report may indicate multiple groups associated with the predicted interference, where each group of the multiple groups is associated with a subset of the predicted interference. In such cases, each group may be associated with a starting resource, an ending resource, a length, or any combination thereof.

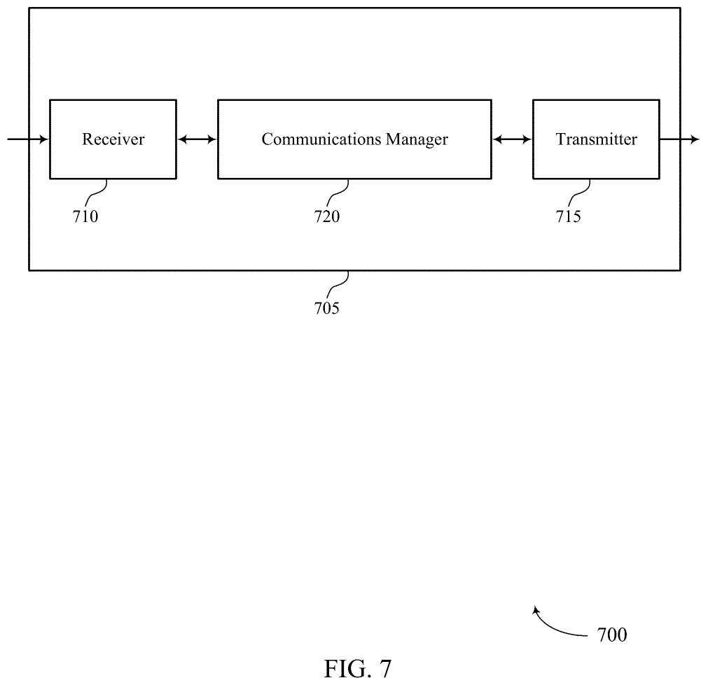

FIG. 7 shows a block diagram 700 of a device 705 that supports techniques for reporting predicted interference to enable advanced link adaptations in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for reporting predicted interference to enable advanced link adaptations). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for reporting predicted interference to enable advanced link adaptations). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of techniques for reporting predicted interference to enable advanced link adaptations as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving a first control message that indicates the UE is to report predicted interference for a set of multiple resources via a single interference report. The communications manager 720 is capable of, configured to, or operable to support a means for predicting interference associated with the set of multiple resources based on receiving the first control message. The communications manager 720 is capable of, configured to, or operable to support a means for determining a payload size of the interference report, a payload structure of the interference report, or both, based on the predicted interference. The communications manager 720 is capable of, configured to, or operable to support a means for transmitting the interference report in accordance with the determined payload size, the determined payload structure, or both.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reporting of predicted interference using a single interference report which may result in reduced processing, reduced power consumption, more efficient utilization of communication resources, among other advantages.

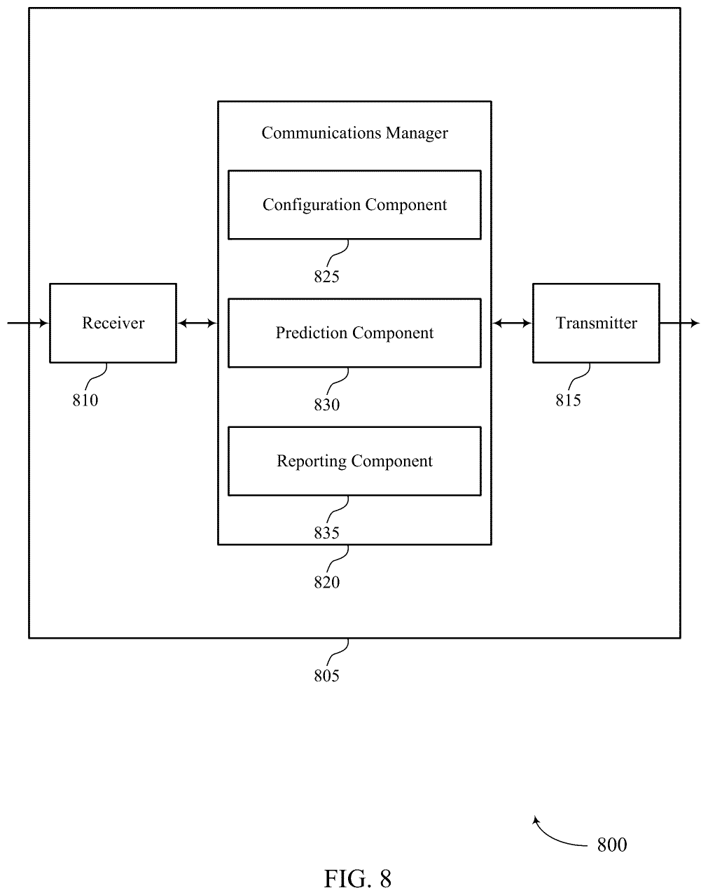

FIG. 8 shows a block diagram 800 of a device 805 that supports techniques for reporting predicted interference to enable advanced link adaptations in accordance with one or more aspects of the present disclosure. The device 805 may be an example of aspects of a device 705 or a UE 115 as described herein. The device 805 may include a receiver 810, a transmitter 815, and a communications manager 820. The device 805, or one of more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for reporting predicted interference to enable advanced link adaptations). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for reporting predicted interference to enable advanced link adaptations). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for reporting predicted interference to enable advanced link adaptations as described herein. For example, the communications manager 820 may include a configuration component 825, a prediction component 830, a reporting component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The configuration component 825 is capable of, configured to, or operable to support a means for receiving a first control message that indicates the UE is to report predicted interference for a set of multiple resources via a single interference report. The prediction component 830 is capable of, configured to, or operable to support a means for predicting interference associated with the set of multiple resources based on receiving the first control message. The reporting component 835 is capable of, configured to, or operable to support a means for determining a payload size of the interference report, a payload structure of the interference report, or both, based on the predicted interference. The reporting component 835 is capable of, configured to, or operable to support a means for transmitting the interference report in accordance with the determined payload size, the determined payload structure, or both.

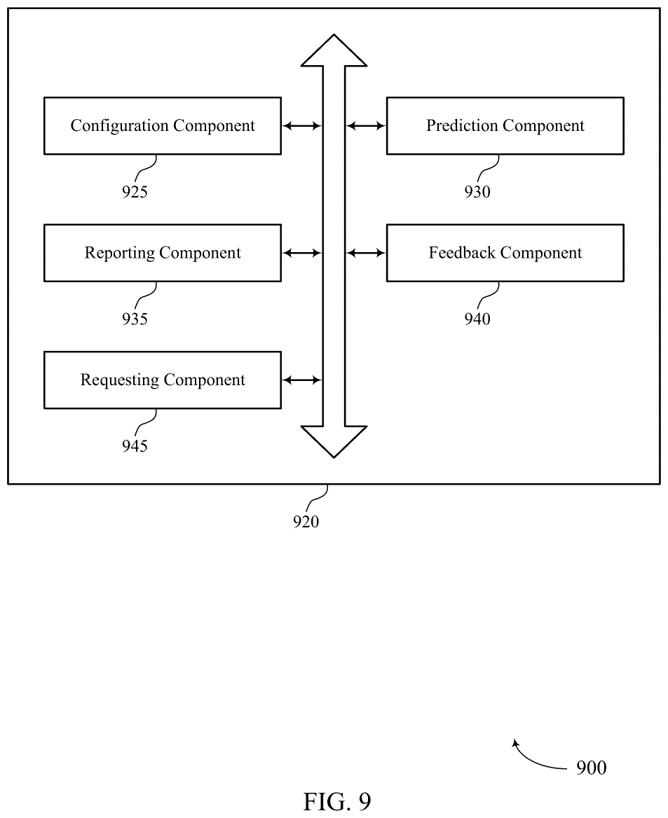

FIG. 9 shows a block diagram 900 of a communications manager 920 that supports techniques for reporting predicted interference to enable advanced link adaptations in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for reporting predicted interference to enable advanced link adaptations as described herein. For example, the communications manager 920 may include a configuration component 925, a prediction component 930, a reporting component 935, a feedback component 940, a requesting component 945, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The configuration component 925 is capable of, configured to, or operable to support a means for receiving a first control message that indicates the UE is to report predicted interference for a set of multiple resources via a single interference report. The prediction component 930 is capable of, configured to, or operable to support a means for predicting interference associated with the set of multiple resources based on receiving the first control message. The reporting component 935 is capable of, configured to, or operable to support a means for determining a payload size of the interference report, a payload structure of the interference report, or both, based on the predicted interference. In some examples, the reporting component 935 is capable of, configured to, or operable to support a means for transmitting the interference report in accordance with the determined payload size, the determined payload structure, or both.

In some examples, to support determining the payload size, the payload structure, or both, the reporting component 935 is capable of, configured to, or operable to support a means for updating the first payload size to a second payload size, the first payload structure to a second payload structure, the first quantity of the set of multiple resources to a second quantity of the set of multiple resources, or any combination thereof, based on the predicted interference, where transmitting the interference report in accordance with the determined payload size, the determined payload structure, or both, includes. In some examples, to support determining the payload size, the payload structure, or both, the reporting component 935 is capable of, configured to, or operable to support a means for transmitting the interference report in accordance with the second payload size, the second payload structure, the second quantity of the set of multiple resources, or any combination thereof, based on the updating.

In some examples, the feedback component 940 is capable of, configured to, or operable to support a means for transmitting a second control message that indicates the second payload size, the second payload structure, the second quantity of the set of multiple resources, or any combination thereof, based on the updating, where transmitting the interference report in accordance with the second payload size, the second payload structure, the second quantity of the set of multiple resources, or any combination thereof, is based on transmitting the second control message.

In some examples, the second control message is a medium access control (MAC)-control element (MAC-CE) message.

In some examples, the first control message indicates a first payload size, and the reporting component 935 is capable of, configured to, or operable to support a means for transmitting a first interference report in accordance the first payload size, the first payload structure, the first quantity of the set of multiple resources, or any combination thereof. In some examples, the first control message indicates a first payload size, and the configuration component 925 is capable of, configured to, or operable to support a means for receiving a second control message that indicates a second payload size, a second payload structure, a second quantity of the set of multiple resources, or any combination thereof, based on transmitting the first interference report, where determining the payload size, the payload structure, or both, includes. In some examples, the first control message indicates a first payload size, and the reporting component 935 is capable of, configured to, or operable to support a means for updating the first payload size to the second payload size, the first payload structure to the second payload structure, the first quantity of the set of multiple resources to the second quantity of the set of multiple resources, or any combination thereof, based on receiving the second control message.

In some examples, the requesting component 945 is capable of, configured to, or operable to support a means for transmitting, via the first interference report, a request to update the first payload size to the second payload size, the first payload structure to the second payload structure, the first quantity of the set of multiple resources to the second quantity of the set of multiple resources, or any combination thereof, where receiving the second control message is based on transmitting the first interference report.

In some examples, to support transmitting the interference report in accordance with the determined payload size, the determined payload structure, or both, the reporting component 935 is capable of, configured to, or operable to support a means for transmitting the interference report in accordance with the second payload size, the second payload structure, the second quantity of the set of multiple resources, or any combination thereof, based on receiving the second control message.

In some examples, the second control message is a MAC-CE message, a DCI message, or an RRC message.

In some examples, to support determining the payload size, the payload structure, or both, the reporting component 935 is capable of, configured to, or operable to support a means for determining to transmit a first subset of the predicted interference associated with a first subset of the set of multiple resources via the interference report in accordance with the first payload size, where transmitting the interference report in accordance with the determined payload size, the determined payload structure, or both, includes. In some examples, to support determining the payload size, the payload structure, or both, the reporting component 935 is capable of, configured to, or operable to support a means for transmitting the interference report that indicates the first subset of the predicted interference associated with the first subset of the set of multiple resources in accordance with the first payload size. In some examples, to support determining the payload size, the payload structure, or both, the reporting component 935 is capable of, configured to, or operable to support a means for transmitting a second control message that indicates a second subset of the predicted interference associated with a second subset of the set of multiple resources based on the determined payload size, the determined payload structure, or both.

In some examples, to support determining the payload size, the payload structure, or both, the reporting component 935 is capable of, configured to, or operable to support a means for adjusting the payload structure based on the first quantity of the resources relative to a second quantity of the set of multiple resources.

In some examples, to support adjusting the payload structure, the reporting component 935 is capable of, configured to, or operable to support a means for inputting NULL into a subset of the set of multiple fields based on the first quantity of the resources exceeding the second quantity of the set of multiple resources.

In some examples, to support adjusting the payload structure, the reporting component 935 is capable of, configured to, or operable to support a means for adjusting a quantity of bits of the set of multiple bits for reporting the predicted interference for each resource of the set of multiple resources based on the first quantity of the resources relative to the second quantity of the set of multiple resources.

In some examples, to support determining the payload size, the payload structure, or both, the reporting component 935 is capable of, configured to, or operable to support a means for selecting a reporting resource from the set of multiple reporting resources based on the predicted interference and based on a respective payload size, respective payload structure, or both, associated with the selected reporting resource.

In some examples, the predicted interference is reported per time duration, per frequency, per spatial resource, or any combination thereof.

In some examples, to support transmitting the interference report, the reporting component 935 is capable of, configured to, or operable to support a means for transmitting the interference report that indicates a set of multiple groups associated with the predicted interference, where each group of the set of multiple groups is associated with a subset of the predicted interference.

In some examples, each group of the set of multiple groups is associated with a starting resource and a length.

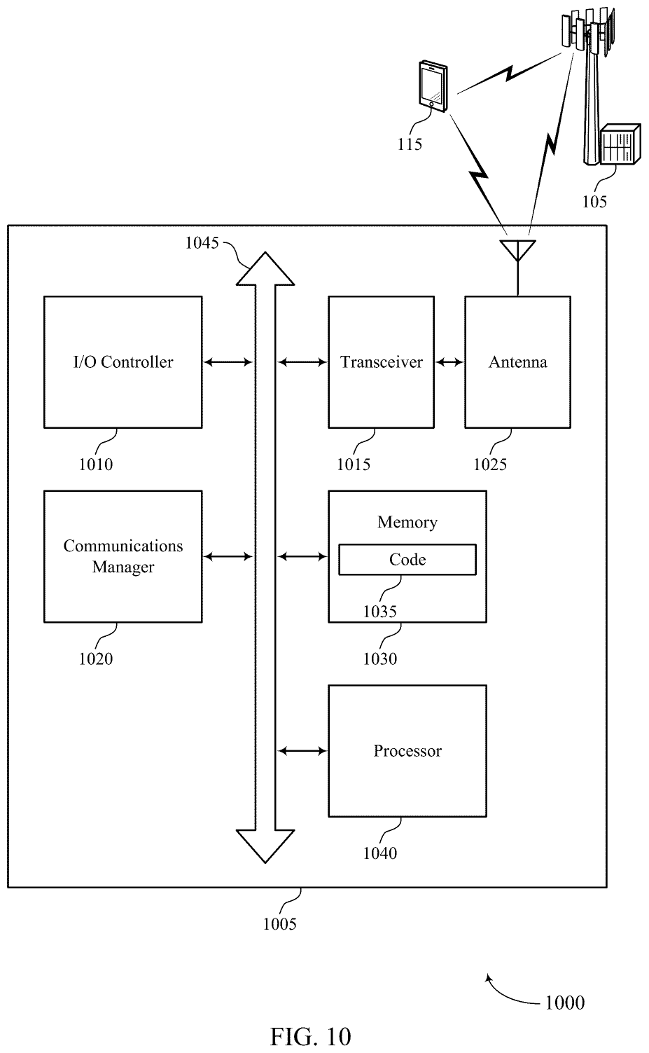

FIG. 10 shows a diagram of a system 1000 including a device 1005 that supports techniques for reporting predicted interference to enable advanced link adaptations in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting techniques for reporting predicted interference to enable advanced link adaptations). For example, the device 1005 or a component of the device 1005 may include at least one processor 1040 and at least one memory 1030 coupled with or to the at least one processor 1040, the at least one processor 1040 and the at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving a first control message that indicates the UE is to report predicted interference for a set of multiple resources via a single interference report. The communications manager 1020 is capable of, configured to, or operable to support a means for predicting interference associated with the set of multiple resources based on receiving the first control message. The communications manager 1020 is capable of, configured to, or operable to support a means for determining a payload size of the interference report, a payload structure of the interference report, or both, based on the predicted interference. The communications manager 1020 is capable of, configured to, or operable to support a means for transmitting the interference report in accordance with the determined payload size, the determined payload structure, or both.

By including or configuring the communications manager 1020 in accordance with examples as described herein, the device 1005 may support techniques for reporting of predicted interference using a single interference report which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of techniques for reporting predicted interference to enable advanced link adaptations as described herein, or the at least one processor 1040 and the at least one memory 1030 may be otherwise configured to, individually or collectively, perform or support such operations.

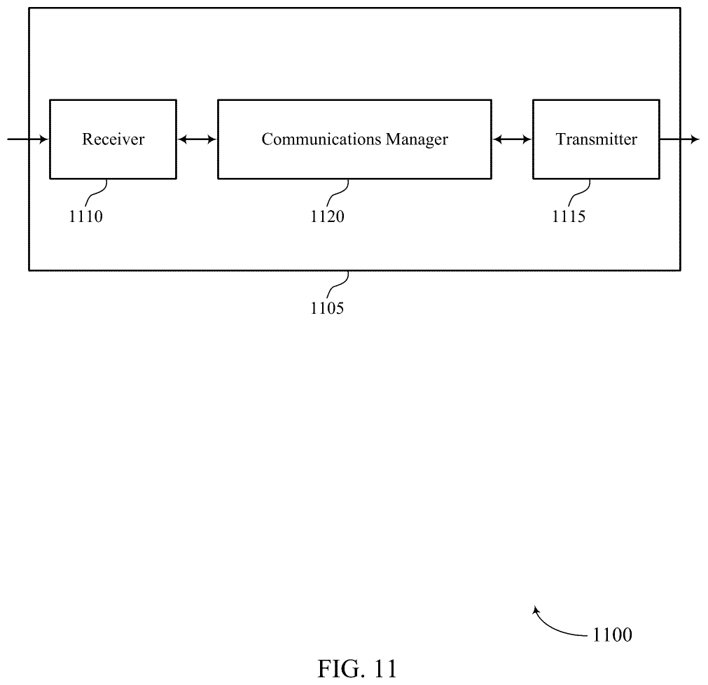

FIG. 11 shows a block diagram 1100 of a device 1105 that supports techniques for reporting predicted interference to enable advanced link adaptations in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of techniques for reporting predicted interference to enable advanced link adaptations as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for transmitting, to a UE, a first control message that indicates the UE is to report predicted interference for a set of multiple resources via a single interference report. The communications manager 1120 is capable of, configured to, or operable to support a means for determining a payload size of the interference report, a payload structure of the interference report, or both. The communications manager 1120 is capable of, configured to, or operable to support a means for receiving the interference report in accordance with the determined payload size, the determined payload structure, or both.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reporting of predicted interference using a single interference report which may result in reduced processing, reduced power consumption, and more efficient utilization of communication resources, among other advantages.

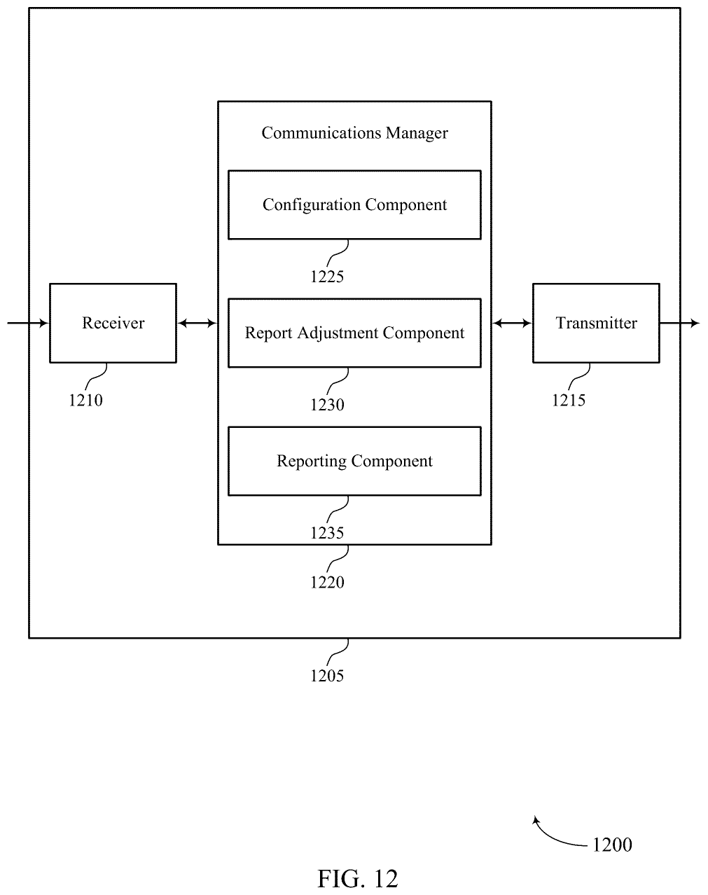

FIG. 12 shows a block diagram 1200 of a device 1205 that supports techniques for reporting predicted interference to enable advanced link adaptations in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one of more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for reporting predicted interference to enable advanced link adaptations as described herein. For example, the communications manager 1220 may include a configuration component 1225, a report adjustment component 1230, a reporting component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The configuration component 1225 is capable of, configured to, or operable to support a means for transmitting, to a UE, a first control message that indicates the UE is to report predicted interference for a set of multiple resources via a single interference report. The report adjustment component 1230 is capable of, configured to, or operable to support a means for determining a payload size of the interference report, a payload structure of the interference report, or both. The reporting component 1235 is capable of, configured to, or operable to support a means for receiving the interference report in accordance with the determined payload size, the determined payload structure, or both.

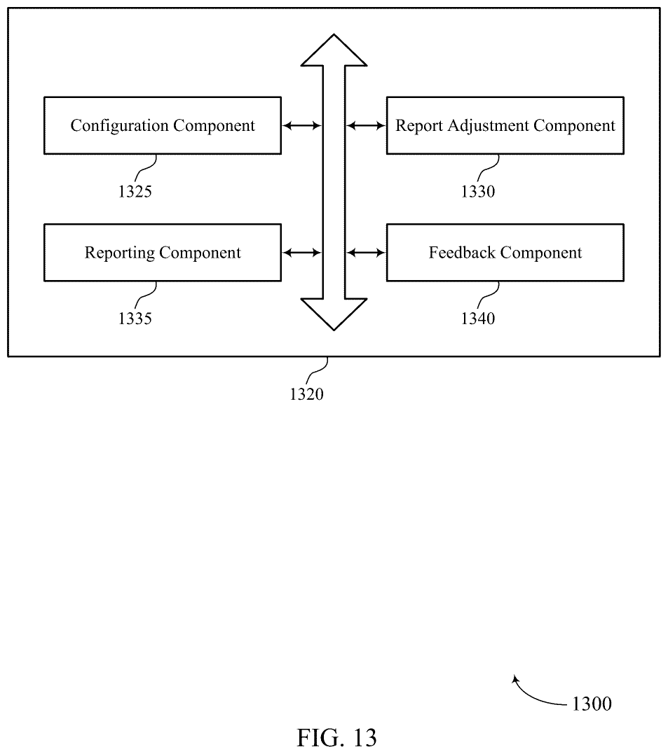

FIG. 13 shows a block diagram 1300 of a communications manager 1320 that supports techniques for reporting predicted interference to enable advanced link adaptations in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for reporting predicted interference to enable advanced link adaptations as described herein. For example, the communications manager 1320 may include a configuration component 1325, a report adjustment component 1330, a reporting component 1335, a feedback component 1340, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The configuration component 1325 is capable of, configured to, or operable to support a means for transmitting, to a UE, a first control message that indicates the UE is to report predicted interference for a set of multiple resources via a single interference report. The report adjustment component 1330 is capable of, configured to, or operable to support a means for determining a payload size of the interference report, a payload structure of the interference report, or both. The reporting component 1335 is capable of, configured to, or operable to support a means for receiving the interference report in accordance with the determined payload size, the determined payload structure, or both.

In some examples, the first control message indicates a first payload size, and the configuration component 1325 is capable of, configured to, or operable to support a means for receiving a second control message that indicates a second payload size, a second payload structure, a second quantity of the set of multiple resources, or any combination thereof, where determining the payload size, the payload structure, or both, is based on receiving the second control message, and where receiving the interference report includes. In some examples, the first control message indicates a first payload size, and the reporting component 1335 is capable of, configured to, or operable to support a means for receiving the interference report in accordance with the second payload size, the second payload structure, the second quantity of the set of multiple resources, or any combination thereof, is based on receiving the second control message.

In some examples, the second control message is a MAC-CE message.

In some examples, the first control message indicates a first payload size, and the reporting component 1335 is capable of, configured to, or operable to support a means for receiving a first interference report in accordance the first payload size, the first payload structure, the first quantity of the set of multiple resources, or any combination thereof, where determining the payload size, the payload structure, or both, includes. In some examples, the first control message indicates a first payload size, and the report adjustment component 1330 is capable of, configured to, or operable to support a means for updating the first payload size to a second payload size, the first payload structure to a second payload structure, the first quantity of the set of multiple resources to a second quantity of the set of multiple resources, or any combination thereof, based on receiving the first interference report. In some examples, the first control message indicates a first payload size, and the configuration component 1325 is capable of, configured to, or operable to support a means for transmitting a second control message that indicates the second payload size, the second payload structure, the second quantity of the set of multiple resources, or any combination thereof, based on the updating.

In some examples, the feedback component 1340 is capable of, configured to, or operable to support a means for receiving, via the first interference report, a request to update the first payload size to the second payload size, the first payload structure to the second payload structure, the first quantity of the set of multiple resources to the second quantity of the set of multiple resources, or any combination thereof, where transmitting the second control message is based on transmitting the first interference report.

In some examples, to support receiving the interference report in accordance with the determined payload size, the determined payload structure, or both, the reporting component 1335 is capable of, configured to, or operable to support a means for receiving the interference report in accordance with the second payload size, the second payload structure, the second quantity of the set of multiple resources, or any combination thereof based on transmitting the second control message.

In some examples, the second control message is a medium access control (MAC)-control element (MAC-CE) message, a DCI message, or an RRC message.

In some examples, to support receiving the interference report in accordance with the determined payload size, the determined payload structure, or both, the reporting component 1335 is capable of, configured to, or operable to support a means for receiving the interference report that indicates a first subset of the predicted interference associated with a first subset of the set of multiple resources in accordance with the first payload size.

In some examples, the configuration component 1325 is capable of, configured to, or operable to support a means for receiving a second control message that indicates a second subset of the predicted interference associated with a second subset of the set of multiple resources based on receiving the interference report that indicates the first subset of the predicted interference associated with the first subset of the set of multiple resources.

In some examples, the set of multiple resources exceeds a threshold set of multiple resources associated with the interference report.

In some examples, to support receiving the interference report in accordance with the determined payload size, the determined payload structure, or both, the reporting component 1335 is capable of, configured to, or operable to support a means for receiving the interference report in accordance with an adjusted payload structure based on the first quantity of the resources relative to a second quantity of the set of multiple resources.

In some examples, to support receiving the interference report in accordance with an adjusted payload structure, the reporting component 1335 is capable of, configured to, or operable to support a means for receiving a value of NULL via a subset of the set of multiple fields based on the first quantity of the resources exceeding the second quantity of the set of multiple resources.

In some examples, to support receiving the interference report in accordance with an adjusted payload structure, the reporting component 1335 is capable of, configured to, or operable to support a means for receiving the interference report that indicates the predicted interference, where a quantity of bits of the set of multiple bits for reporting the predicted interference for each resource of the set of multiple resources is adjusted based on the first quantity of the resources relative to the second quantity of the set of multiple resources.

In some examples, the first control message indicates a set of multiple reporting resources associated with a set of multiple payload sizes, associated with a set of multiple payload structures, or associated with both.

In some examples, the predicted interference is reported per time duration, per frequency, per spatial resource, or any combination thereof.

In some examples, to support receiving the interference report, the reporting component 1335 is capable of, configured to, or operable to support a means for receiving the interference report that indicates a set of multiple groups associated with the predicted interference, where each group of the set of multiple groups is associated with a subset of the predicted interference.

In some examples, each group of the set of multiple groups is associated with a starting resource and a length.

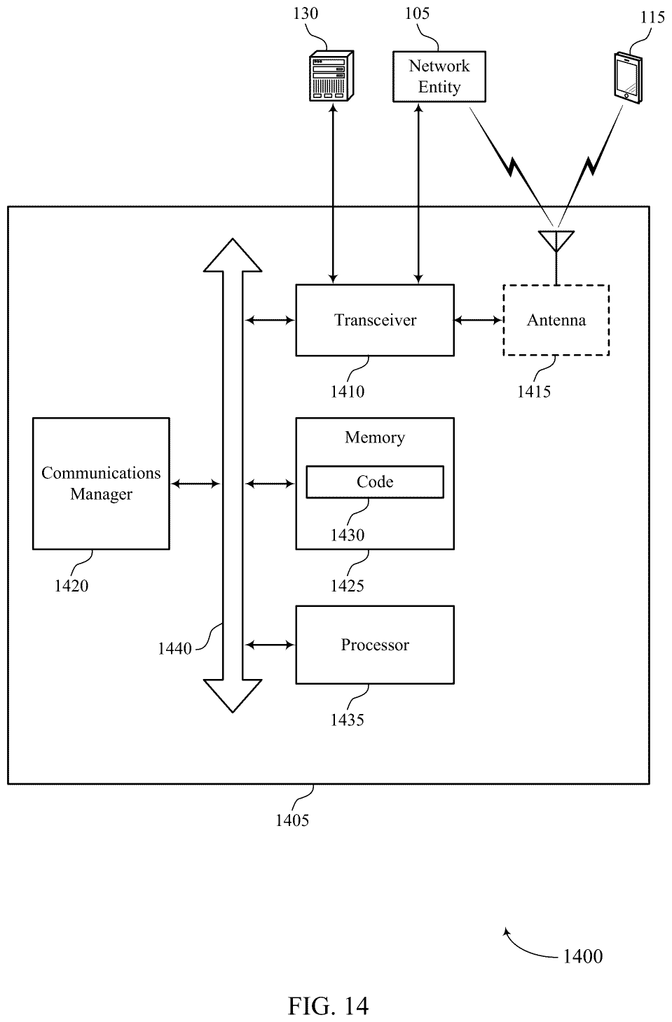

FIG. 14 shows a diagram of a system 1400 including a device 1405 that supports techniques for reporting predicted interference to enable advanced link adaptations in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting techniques for reporting predicted interference to enable advanced link adaptations). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425). In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network devices 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for transmitting, to a UE, a first control message that indicates the UE is to report predicted interference for a set of multiple resources via a single interference report. The communications manager 1420 is capable of, configured to, or operable to support a means for determining a payload size of the interference report, a payload structure of the interference report, or both. The communications manager 1420 is capable of, configured to, or operable to support a means for receiving the interference report in accordance with the determined payload size, the determined payload structure, or both.

By including or configuring the communications manager 1420 in accordance with examples as described herein, the device 1405 may support techniques for reporting of predicted interference using a single interference report which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of techniques for reporting predicted interference to enable advanced link adaptations as described herein, or the at least one processor 1435 and the at least one memory 1425 may be otherwise configured to, individually or collectively, perform or support such operations.

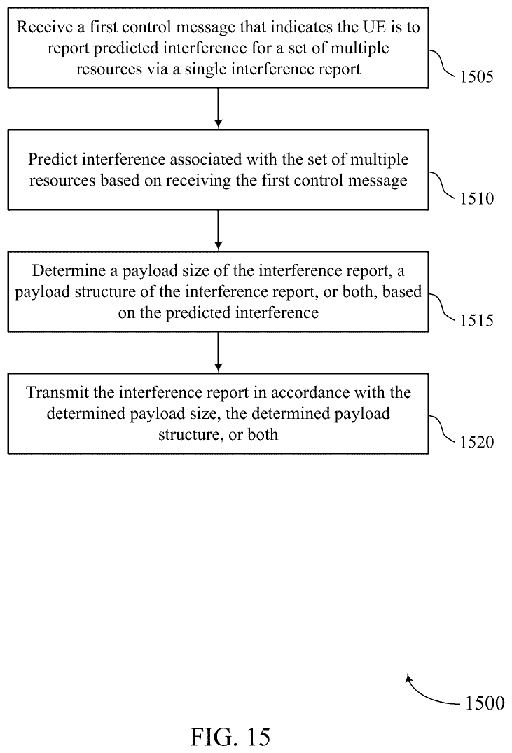

FIG. 15 shows a flowchart illustrating a method 1500 that supports techniques for reporting predicted interference to enable advanced link adaptations in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving a first control message that indicates the UE is to report predicted interference for a set of multiple resources via a single interference report. The operations of 1505 may be performed in accordance with examples as disclosed herein. In some examples, aspects of the operations of 1505 may be performed by a configuration component 925 as described with reference to FIG. 9.

At 1510, the method may include predicting interference associated with the set of multiple resources based on receiving the first control message. The operations of 1510 may be performed in accordance with examples as disclosed herein. In some examples, aspects of the operations of 1510 may be performed by a prediction component 930 as described with reference to FIG. 9.

At 1515, the method may include determining a payload size of the interference report, a payload structure of the interference report, or both, based on the predicted interference. The operations of 1515 may be performed in accordance with examples as disclosed herein. In some examples, aspects of the operations of 1515 may be performed by a reporting component 935 as described with reference to FIG. 9.

At 1520, the method may include transmitting the interference report in accordance with the determined payload size, the determined payload structure, or both. The operations of 1520 may be performed in accordance with examples as disclosed herein. In some examples, aspects of the operations of 1520 may be performed by a reporting component 935 as described with reference to FIG. 9.

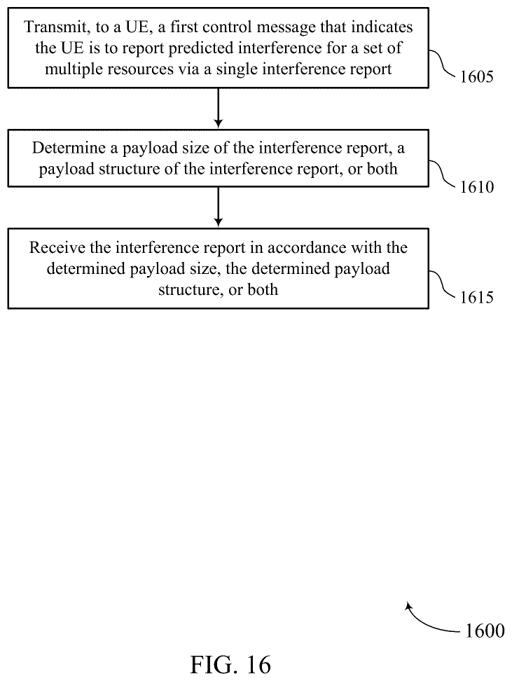

FIG. 16 shows a flowchart illustrating a method 1600 that supports techniques for reporting predicted interference to enable advanced link adaptations in accordance with one or more aspects of the present disclosure. The operations of the method 1600 may be implemented by a network entity or its components as described herein. For example, the operations of the method 1600 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to a UE, a first control message that indicates the UE is to report predicted interference for a set of multiple resources via a single interference report. The operations of 1605 may be performed in accordance with examples as disclosed herein. In some examples, aspects of the operations of 1605 may be performed by a configuration component 1325 as described with reference to FIG. 13.

At 1610, the method may include determining a payload size of the interference report, a payload structure of the interference report, or both. The operations of 1610 may be performed in accordance with examples as disclosed herein. In some examples, aspects of the operations of 1610 may be performed by a report adjustment component 1330 as described with reference to FIG. 13.

At 1615, the method may include receiving the interference report in accordance with the determined payload size, the determined payload structure, or both. The operations of 1615 may be performed in accordance with examples as disclosed herein. In some examples, aspects of the operations of 1615 may be performed by a reporting component 1335 as described with reference to FIG. 13.

The following provides an overview of aspects of the present disclosure:

Aspect 1: A method for wireless communications at a UE, comprising: receiving a first control message that indicates the UE is to report predicted interference for a plurality of resources via a single interference report; predicting interference associated with the plurality of resources based at least in part on receiving the first control message; determining a payload size of the interference report, a payload structure of the interference report, or both, based at least in part on the predicted interference; and transmitting the interference report in accordance with the determined payload size, the determined payload structure, or both.

Aspect 2: The method of aspect 1, wherein the first control message indicates a first payload size, a first payload structure, a first quantity of the plurality of resources, or any combination thereof, and wherein determining the payload size, the payload structure, or both, comprises: updating the first payload size to a second payload size, the first payload structure to a second payload structure, the first quantity of the plurality of resources to a second quantity of the plurality of resources, or any combination thereof, based at least in part on the predicted interference, wherein transmitting the interference report in accordance with the determined payload size, the determined payload structure, or both, comprises: transmitting the interference report in accordance with the second payload size, the second payload structure, the second quantity of the plurality of resources, or any combination thereof, based at least in part on the updating.

Aspect 3: The method of aspect 2, further comprising: transmitting a second control message that indicates the second payload size, the second payload structure, the second quantity of the plurality of resources, or any combination thereof, based at least in part on the updating, wherein transmitting the interference report in accordance with the second payload size, the second payload structure, the second quantity of the plurality of resources, or any combination thereof, is based at least in part on transmitting the second control message.

Aspect 4: The method of aspect 3, wherein the second control message is a MAC-CE message.

Aspect 5: The method of any of aspects 1 through 4, wherein the first control message indicates a first payload size, a first payload structure, a first quantity of the plurality of resources, or any combination thereof, the method further comprising: transmitting a first interference report in accordance the first payload size, the first payload structure, the first quantity of the plurality of resources, or any combination thereof; and receiving a second control message that indicates a second payload size, a second payload structure, a second quantity of the plurality of resources, or any combination thereof, based at least in part on transmitting the first interference report, wherein determining the payload size, the payload structure, or both, comprises: updating the first payload size to the second payload size, the first payload structure to the second payload structure, the first quantity of the plurality of resources to the second quantity of the plurality of resources, or any combination thereof, based at least in part on receiving the second control message.

Aspect 6: The method of aspect 5, further comprising: transmitting, via the first interference report, a request to update the first payload size to the second payload size, the first payload structure to the second payload structure, the first quantity of the plurality of resources to the second quantity of the plurality of resources, or any combination thereof, wherein receiving the second control message is based at least in part on transmitting the first interference report.

Aspect 7: The method of any of aspects 5 through 6, wherein transmitting the interference report in accordance with the determined payload size, the determined payload structure, or both, comprises: transmitting the interference report in accordance with the second payload size, the second payload structure, the second quantity of the plurality of resources, or any combination thereof, based at least in part on receiving the second control message.

Aspect 8: The method of any of aspects 5 through 7, wherein the second control message is a MAC-CE message, a DCI message, or an RRC message.

Aspect 9: The method of any of aspects 1 through 8, wherein the first control message indicates a first payload size, and wherein determining the payload size, the payload structure, or both, comprises: determining to transmit a first subset of the predicted interference associated with a first subset of the plurality of resources via the interference report in accordance with the first payload size, wherein transmitting the interference report in accordance with the determined payload size, the determined payload structure, or both, comprises: transmitting the interference report that indicates the first subset of the predicted interference associated with the first subset of the plurality of resources in accordance with the first payload size; and transmitting a second control message that indicates a second subset of the predicted interference associated with a second subset of the plurality of resources based at least in part on the determined payload size, the determined payload structure, or both.

Aspect 10: The method of any of aspects 1 through 9, wherein the first control message indicates a first payload size associated with a first quantity of resources, and wherein determining the payload size, the payload structure, or both, comprises: adjusting the payload structure based at least in part on the first quantity of the resources relative to a second quantity of the plurality of resources.

Aspect 11: The method of aspect 10, wherein the first payload size is associated with a plurality of fields for reporting the predicted interference, and wherein adjusting the payload structure comprises: inputting NULL into a subset of the plurality of fields based at least in part on the first quantity of the resources exceeding the second quantity of the plurality of resources.

Aspect 12: The method of any of aspects 10 through 11, wherein the first payload size is associated with a plurality of bits for reporting the predicted interference, and wherein adjusting the payload structure comprises: adjusting a quantity of bits of the plurality of bits for reporting the predicted interference for each resource of the plurality of resources based at least in part on the first quantity of the resources relative to the second quantity of the plurality of resources.

Aspect 13: The method of any of aspects 1 through 12, wherein the first control message indicates a plurality of reporting resources associated with a plurality of payload sizes, associated with a plurality of payload structures, or associated with both, and wherein determining the payload size, the payload structure, or both, comprises: selecting a reporting resource from the plurality of reporting resources based at least in part on the predicted interference and based at least in part on a respective payload size, respective payload structure, or both, associated with the selected reporting resource.

Aspect 14: The method of any of aspects 1 through 13, wherein the predicted interference is reported per time duration, per frequency, per spatial resource, or any combination thereof.

Aspect 15: The method of any of aspects 1 through 14, wherein transmitting the interference report comprises: transmitting the interference report that indicates a plurality of groups associated with the predicted interference, wherein each group of the plurality of groups is associated with a subset of the predicted interference.

Aspect 16: The method of aspect 15, wherein each group of the plurality of groups is associated with a starting resource and a length.

Aspect 17: A method for wireless communications at a network entity, comprising: transmitting, to a UE, a first control message that indicates the UE is to report predicted interference for a plurality of resources via a single interference report; determining a payload size of the interference report, a payload structure of the interference report, or both; and receiving the interference report in accordance with the determined payload size, the determined payload structure, or both.

Aspect 18: The method of aspect 17, wherein the first control message indicates a first payload size, a first payload structure, a first quantity of the plurality of resources, or any combination thereof, the method further comprising: receiving a second control message that indicates a second payload size, a second payload structure, a second quantity of the plurality of resources, or any combination thereof, wherein determining the payload size, the payload structure, or both, is based at least in part on receiving the second control message, and wherein receiving the interference report comprises: receiving the interference report in accordance with the second payload size, the second payload structure, the second quantity of the plurality of resources, or any combination thereof, is based at least in part on receiving the second control message.

Aspect 19: The method of aspect 18, wherein the second control message is a MAC-CE message.

Aspect 20: The method of any of aspects 17 through 19, wherein the first control message indicates a first payload size, a first payload structure, a first quantity of the plurality of resources, or any combination thereof, the method further comprising: receiving a first interference report in accordance the first payload size, the first payload structure, the first quantity of the plurality of resources, or any combination thereof, wherein determining the payload size, the payload structure, or both, comprises: updating the first payload size to a second payload size, the first payload structure to a second payload structure, the first quantity of the plurality of resources to a second quantity of the plurality of resources, or any combination thereof, based at least in part on receiving the first interference report; and transmitting a second control message that indicates the second payload size, the second payload structure, the second quantity of the plurality of resources, or any combination thereof, based at least in part on the updating.

Aspect 21: The method of aspect 20, further comprising: receiving, via the first interference report, a request to update the first payload size to the second payload size, the first payload structure to the second payload structure, the first quantity of the plurality of resources to the second quantity of the plurality of resources, or any combination thereof, wherein transmitting the second control message is based at least in part on transmitting the first interference report.

Aspect 22: The method of any of aspects 20 through 21, wherein receiving the interference report in accordance with the determined payload size, the determined payload structure, or both, comprises: receiving the interference report in accordance with the second payload size, the second payload structure, the second quantity of the plurality of resources, or any combination thereof based at least in part on transmitting the second control message.

Aspect 23: The method of any of aspects 20 through 22, wherein the second control message is a MAC-CE message, a DCI message, or an RRC message.

Aspect 24: The method of any of aspects 17 through 23, wherein the first control message indicates a first payload size, wherein determining the payload size, the payload structure, or both, is based at least in part on transmitting the first control message, and wherein receiving the interference report in accordance with the determined payload size, the determined payload structure, or both, comprises: receiving the interference report that indicates a first subset of the predicted interference associated with a first subset of the plurality of resources in accordance with the first payload size.

Aspect 25: The method of aspect 24, further comprising: receiving a second control message that indicates a second subset of the predicted interference associated with a second subset of the plurality of resources based at least in part on receiving the interference report that indicates the first subset of the predicted interference associated with the first subset of the plurality of resources.

Aspect 26: The method of any of aspects 24 through 25, wherein the plurality of resources exceeds a threshold plurality of resources associated with the interference report.

Aspect 27: The method of any of aspects 17 through 26, wherein the first control message indicates a first payload size associated with a first quantity of resources, wherein determining the payload size, the payload structure, or both, is based at least in part on transmitting the first control message, and wherein receiving the interference report in accordance with the determined payload size, the determined payload structure, or both, comprises: receiving the interference report in accordance with an adjusted payload structure based at least in part on the first quantity of the resources relative to a second quantity of the plurality of resources.

Aspect 28: The method of aspect 27, wherein the first payload size is associated with a plurality of fields for reporting the predicted interference, and wherein receiving the interference report in accordance with an adjusted payload structure comprises: receiving a value of NULL via a subset of the plurality of fields based at least in part on the first quantity of the resources exceeding the second quantity of the plurality of resources.

Aspect 29: The method of any of aspects 27 through 28, wherein the first payload size is associated with a plurality of fields for reporting the predicted interference, and wherein receiving the interference report in accordance with an adjusted payload structure comprises: receiving the interference report that indicates the predicted interference, wherein a quantity of bits of the plurality of bits for reporting the predicted interference for each resource of the plurality of resources is adjusted based at least in part on the first quantity of the resources relative to the second quantity of the plurality of resources.

Aspect 30: The method of any of aspects 17 through 29, wherein the first control message indicates a plurality of reporting resources associated with a plurality of payload sizes, associated with a plurality of payload structures, or associated with both.

Aspect 31: The method of any of aspects 17 through 30, wherein the predicted interference is reported per time duration, per frequency, per spatial resource, or any combination thereof.

Aspect 32: The method of any of aspects 17 through 31, wherein receiving the interference report comprises: receiving the interference report that indicates a plurality of groups associated with the predicted interference, wherein each group of the plurality of groups is associated with a subset of the predicted interference.

Aspect 33: The method of aspect 32, wherein each group of the plurality of groups is associated with a starting resource and a length.

Aspect 34: A UE for wireless communications, comprising one or more memories storing processor-executable code, and one or more processors coupled with the one or more memories and individually or collectively operable to execute the code to cause the UE to perform a method of any of aspects 1 through 16.

Aspect 35: A UE for wireless communications, comprising at least one means for performing a method of any of aspects 1 through 16.

Aspect 36: A non-transitory computer-readable medium storing code for wireless communications, the code comprising instructions executable by one or more processors to perform a method of any of aspects 1 through 16.

Aspect 37: A network entity for wireless communications, comprising one or more memories storing processor-executable code, and one or more processors coupled with the one or more memories and individually or collectively operable to execute the code to cause the network entity to perform a method of any of aspects 17 through 33.

Aspect 38: A network entity for wireless communications, comprising at least one means for performing a method of any of aspects 17 through 33.

Aspect 39: A non-transitory computer-readable medium storing code for wireless communications, the code comprising instructions executable by one or more processors to perform a method of any of aspects 17 through 33.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first control message that indicates the UE is to report predicted interference for a plurality of resources via a single interference report;
predict interference associated with the plurality of resources based at least in part on receiving the first control message;
determine a payload size of the interference report, a payload structure of the interference report, or both, based at least in part on the predicted interference; and
transmit the interference report in accordance with the determined payload size, the determined payload structure, or both.

2. The UE of claim 1, wherein the first control message indicates a first payload size, a first payload structure, a first quantity of the plurality of resources, or any combination thereof, and wherein, to determine the payload size, the payload structure, or both, the one or more processors are individually or collectively operable to execute the code to cause the UE to:
update the first payload size to a second payload size, the first payload structure to a second payload structure, the first quantity of the plurality of resources to a second quantity of the plurality of resources, or any combination thereof, based at least in part on the predicted interference, wherein transmitting the interference report in accordance with the determined payload size, the determined payload structure, or both, comprises:
transmit the interference report in accordance with the second payload size, the second payload structure, the second quantity of the plurality of resources, or any combination thereof, based at least in part on the updating.

3. The UE of claim 2, wherein the one or more processors are individually or collectively further operable to execute the code to cause the UE to:
transmit a second control message that indicates the second payload size, the second payload structure, the second quantity of the plurality of resources, or any combination thereof, based at least in part on the updating, wherein transmitting the interference report in accordance with the second payload size, the second payload structure, the second quantity of the plurality of resources, or any combination thereof, is based at least in part on transmitting the second control message.

4. The UE of claim 3, wherein the second control message is a medium access control (MAC)-control element (MAC-CE) message.

5. The UE of claim 1, wherein the first control message indicates a first payload size, a first payload structure, a first quantity of the plurality of resources, or any combination thereof, and the one or more processors are individually or collectively further operable to execute the code to cause the UE to:
transmit a first interference report in accordance the first payload size, the first payload structure, the first quantity of the plurality of resources, or any combination thereof; and
receive a second control message that indicates a second payload size, a second payload structure, a second quantity of the plurality of resources, or any combination thereof, based at least in part on transmitting the first interference report, wherein determining the payload size, the payload structure, or both, comprises:
update the first payload size to the second payload size, the first payload structure to the second payload structure, the first quantity of the plurality of resources to the second quantity of the plurality of resources, or any combination thereof, based at least in part on receiving the second control message.

6. The UE of claim 5, wherein the one or more processors are individually or collectively further operable to execute the code to cause the UE to:
transmit, via the first interference report, a request to update the first payload size to the second payload size, the first payload structure to the second payload structure, the first quantity of the plurality of resources to the second quantity of the plurality of resources, or any combination thereof, wherein receiving the second control message is based at least in part on transmitting the first interference report.

7. The UE of claim 5, wherein, to transmit the interference report in accordance with the determined payload size, the determined payload structure, or both, the one or more processors are individually or collectively operable to execute the code to cause the UE to:
transmit the interference report in accordance with the second payload size, the second payload structure, the second quantity of the plurality of resources, or any combination thereof, based at least in part on receiving the second control message.

8. The UE of claim 1, wherein the first control message indicates a first payload size, and wherein, to determine the payload size, the payload structure, or both, the one or more processors are individually or collectively operable to execute the code to cause the UE to:
determine to transmit a first subset of the predicted interference associated with a first subset of the plurality of resources via the interference report in accordance with the first payload size, wherein transmitting the interference report in accordance with the determined payload size, the determined payload structure, or both, comprises:
transmit the interference report that indicates the first subset of the predicted interference associated with the first subset of the plurality of resources in accordance with the first payload size; and
transmit a second control message that indicates a second subset of the predicted interference associated with a second subset of the plurality of resources based at least in part on the determined payload size, the determined payload structure, or both.

9. The UE of claim 1, wherein the first control message indicates a first payload size associated with a first quantity of resources, and wherein, to determine the payload size, the payload structure, or both, the one or more processors are individually or collectively operable to execute the code to cause the UE to:
adjust the payload structure based at least in part on the first quantity of the resources relative to a second quantity of the plurality of resources.

10. The UE of claim 9, wherein the first payload size is associated with a plurality of fields for reporting the predicted interference, and wherein, to adjust the payload structure, the one or more processors are individually or collectively operable to execute the code to cause the UE to:
input NULL into a subset of the plurality of fields based at least in part on the first quantity of the resources exceeding the second quantity of the plurality of resources.

11. The UE of claim 9, wherein the first payload size is associated with a plurality of bits for reporting the predicted interference, and wherein, to adjust the payload structure, the one or more processors are individually or collectively operable to execute the code to cause the UE to:
adjust a quantity of bits of the plurality of bits for reporting the predicted interference for each resource of the plurality of resources based at least in part on the first quantity of the resources relative to the second quantity of the plurality of resources.

12. The UE of claim 1, wherein the first control message indicates a plurality of reporting resources associated with a plurality of payload sizes, associated with a plurality of payload structures, or associated with both, and wherein, to determine the payload size, the payload structure, or both, the one or more processors are individually or collectively operable to execute the code to cause the UE to:
select a reporting resource from the plurality of reporting resources based at least in part on the predicted interference and based at least in part on a respective payload size, respective payload structure, or both, associated with the selected reporting resource.

13. The UE of claim 1, wherein the predicted interference is reported per time duration, per frequency, per spatial resource, or any combination thereof.

14. The UE of claim 1, wherein, to transmit the interference report, the one or more processors are individually or collectively operable to execute the code to cause the UE to:
transmit the interference report that indicates a plurality of groups associated with the predicted interference, wherein each group of the plurality of groups is associated with a subset of the predicted interference.

15. A network entity, comprising:
one or more memories storing processor-executable code; and
one or more processors coupled with the one or more memories and individually or collectively operable to execute the code to cause the network entity to:
transmit, to a user equipment (UE), a first control message that indicates the UE is to report predicted interference for a plurality of resources via a single interference report;
determine a payload size of the interference report, a payload structure of the interference report, or both; and
receive the interference report in accordance with the determined payload size, the determined payload structure, or both.

16. The network entity of claim 15, wherein the first control message indicates a first payload size, a first payload structure, a first quantity of the plurality of resources, or any combination thereof, and the one or more processors are individually or collectively further operable to execute the code to cause the network entity to:
receive a second control message that indicates a second payload size, a second payload structure, a second quantity of the plurality of resources, or any combination thereof, wherein determining the payload size, the payload structure, or both, is based at least in part on receiving the second control message, and wherein receiving the interference report comprises:
receive the interference report in accordance with the second payload size, the second payload structure, the second quantity of the plurality of resources, or any combination thereof, is based at least in part on receiving the second control message.

17. The network entity of claim 15, wherein the first control message indicates a first payload size, a first payload structure, a first quantity of the plurality of resources, or any combination thereof, and the one or more processors are individually or collectively further operable to execute the code to cause the network entity to:
receive a first interference report in accordance the first payload size, the first payload structure, the first quantity of the plurality of resources, or any combination thereof, wherein determining the payload size, the payload structure, or both, comprises:
update the first payload size to a second payload size, the first payload structure to a second payload structure, the first quantity of the plurality of resources to a second quantity of the plurality of resources, or any combination thereof, based at least in part on receiving the first interference report; and
transmit a second control message that indicates the second payload size, the second payload structure, the second quantity of the plurality of resources, or any combination thereof, based at least in part on the updating.

18. The network entity of claim 17, wherein the one or more processors are individually or collectively further operable to execute the code to cause the network entity to:
receive, via the first interference report, a request to update the first payload size to the second payload size, the first payload structure to the second payload structure, the first quantity of the plurality of resources to the second quantity of the plurality of resources, or any combination thereof, wherein transmitting the second control message is based at least in part on transmitting the first interference report.

19. The network entity of claim 17, wherein, to receive the interference report in accordance with the determined payload size, the determined payload structure, or both, the one or more processors are individually or collectively operable to execute the code to cause the network entity to:
receive the interference report in accordance with the second payload size, the second payload structure, the second quantity of the plurality of resources, or any combination thereof based at least in part on transmitting the second control message.

20. The network entity of claim 15, wherein the first control message indicates a first payload size, wherein determining the payload size, the payload structure, or both, is based at least in part on transmitting the first control message, and wherein, to receive the interference report in accordance with the determined payload size, the determined payload structure, or both, the one or more processors are individually or collectively operable to execute the code to cause the network entity to:
receive the interference report that indicates a first subset of the predicted interference associated with a first subset of the plurality of resources in accordance with the first payload size.

21. The network entity of claim 20, wherein the one or more processors are individually or collectively further operable to execute the code to cause the network entity to:
receive a second control message that indicates a second subset of the predicted interference associated with a second subset of the plurality of resources based at least in part on receiving the interference report that indicates the first subset of the predicted interference associated with the first subset of the plurality of resources.

22. The network entity of claim 20, wherein the plurality of resources exceeds a threshold plurality of resources associated with the interference report.

23. The network entity of claim 15, wherein the first control message indicates a first payload size associated with a first quantity of resources, and wherein, to receive the interference report in accordance with the determined payload size, the determined payload structure, or both, the one or more processors are individually or collectively operable to execute the code to cause the network entity to:
receive the interference report in accordance with an adjusted payload structure based at least in part on the first quantity of the resources relative to a second quantity of the plurality of resources.

24. The network entity of claim 23, wherein the first payload size is associated with a plurality of fields for reporting the predicted interference, and wherein, to receive the interference report in accordance with an adjusted payload structure, the one or more processors are individually or collectively operable to execute the code to cause the network entity to:
receive a value of NULL via a subset of the plurality of fields based at least in part on the first quantity of the resources exceeding the second quantity of the plurality of resources.

25. The network entity of claim 23, wherein the first payload size is associated with a plurality of fields for reporting the predicted interference, and wherein, to receive the interference report in accordance with an adjusted payload structure, the one or more processors are individually or collectively operable to execute the code to cause the network entity to:
receive the interference report that indicates the predicted interference, wherein a quantity of bits of the plurality of bits for reporting the predicted interference for each resource of the plurality of resources is adjusted based at least in part on the first quantity of the resources relative to the second quantity of the plurality of resources.

26. The network entity of claim 15, wherein the first control message indicates a plurality of reporting resources associated with a plurality of payload sizes, associated with a plurality of payload structures, or associated with both.

27. The network entity of claim 15, wherein the predicted interference is reported per time duration, per frequency, per spatial resource, or any combination thereof.

28. The network entity of claim 15, wherein, to receive the interference report, the one or more processors are individually or collectively operable to execute the code to cause the network entity to:
receive the interference report that indicates a plurality of groups associated with the predicted interference, wherein each group of the plurality of groups is associated with a subset of the predicted interference.

29. A method for wireless communications at a user equipment (UE), comprising:
receiving a first control message that indicates the UE is to report predicted interference for a plurality of resources via a single interference report;
predicting interference associated with the plurality of resources based at least in part on receiving the first control message;
determining a payload size of the interference report, a payload structure of the interference report, or both, based at least in part on the predicted interference; and
transmitting the interference report in accordance with the determined payload size, the determined payload structure, or both.

30. A method for wireless communications at a network entity, comprising:
transmitting, to a user equipment (UE), a first control message that indicates the UE is to report predicted interference for a plurality of resources via a single interference report;
determining a payload size of the interference report, a payload structure of the interference report, or both; and
receiving the interference report in accordance with the determined payload size, the determined payload structure, or both.
